(19) United States
(12) Patent Application Publication
(10) Pub. No.: US 2005/0223046 A1
(43) Pub. Date: Oct. 6, 2005

(54) Method and system for balancing and scheduling database maintenance tasks

(76) Inventor: Rick A. Smith, Austin, TX (US)

Correspondence Address: Rick B. Yeager, 10805 Mellow Lane, Austin, TX, 78759, US

(21) Appl. No.: 11/100,170

(22) Filed: Apr. 6, 2005

Related U.S. Application Data
(60) Provisional application No. 60/559,712, filed on Apr. 6, 2004.
(60) Provisional application No. 60/616,326, filed on Oct. 6, 2004.

(51) Int. Cl. G06F 7/00

(52) U.S. Cl. 707/200

(57) ABSTRACT

Database administrators input database object characteristics and constraints, and maintenance tasks such as object statistics, reorganization, copy, and recovery tasks are prioritized and balanced with a dynamically generated grid of tasks. Reorganization tasks are directly linked to statistics generation and threshold violation analysis. Recovery tasks are automatically generated from copy tasks. The dynamically generated grid distributes database objects across concurrent procedures, based on criteria such as cumulative job size so that each set of procedures process approximately the same amount of data. Maintenance procedures are built and executed in a controlled manner according to maintenance policies of an organization. The user knows what objects will be processed, prior to a maintenance window.

### RELATED APPLICATIONS

This application is related to and claims the benefit of U.S. Provisional Application No. 60/559712 filed on Apr. 6, 2004 by applicant for “Method and system for balancing and scheduling database maintenance tasks”. This application is related to and claims the benefit of U.S. Provisional Application No. 60/616326 filed on Oct. 6, 2004 by applicant for “Method and system for balancing and scheduling database copy maintenance tasks and generating recovery tasks from the copy tasks”.

### FIELD OF INVENTION

This invention relates to a method and system for scheduling and balancing database maintenance tasks, including object statistics, reorganization, copy, and recovery tasks.

### BACKGROUND OF THE INVENTION

In order to maintain operational efficiency in computer systems that use databases, it is desirable to periodically reorganize database objects. Database administrators typically monitor objects, using threshold criteria, to know when reorganization is required. Two examples of threshold criteria are 1) cluster ratio, the degree to which the ordering of the index entries physically parallel the table data entries, and 2) number of extents, the actual number of physical pieces that comprise a dataset or file. For example 1, as the ratio decreases, adding to computer resource overhead, the need for reorganization increases. For example 2, as the number of extents increase, adding to computer resource overhead, the need for reorganization increases. A database administrator typically monitors these, and other, threshold criteria, to maintain performance objectives for an organization.

In order to satisfy recovery requirements in computer systems that use databases, it is desirable to periodically copy or backup database objects. Database administrators typically build executable units or utility jobs to copy or backup objects. Additionally, recovery utility jobs are required, in case an object, or group of objects, need to be recovered. A database administrator typically builds or generates these utility jobs and corresponding control cards manually or semi-automatically.

One problem that is present in many computing environments is that different database administrators may use different threshold criteria for when to reorganize objects. Additionally, these database administrators may use a different approach when it comes to building the utility jobs and control cards. In these situations, it is unlikely that optimum efficiency or optimum scheduling can be achieved or maintained. A major objective of the current invention is to provide a consistent framework for analyzing, balancing, and scheduling these tasks, so that computer resources are used efficiently, and the maintenance window is fully utilized. Another major objective of the current invention, as it relates to copying and recovering database objects, is the automatic generation of the recovery tasks based on the copy tasks. The recovery tasks are generated at the same time the copy tasks are generated. The reason for this approach is that the generation of the copy tasks should be driven by how database objects need to be recovered. The current invention uses this approach so that recovery tasks match how database objects were copied or backed up. This means that disaster recovery utility jobs and control cards are automatically generated and are always current.

In addition to the reorganization of database objects and copying those objects, most computing environments typically have change management systems that impose restrictions on the ability to modify data. For instance, in normal operation, database maintenance tasks may be performed weekly, such as on a Sunday, but the deadline to schedule those tasks may be on the preceding Tuesday. From a change management perspective, it is desirable to lock in the job schedule as of an earlier date, such as the Tuesday before the jobs are executed. The change management team tracks these jobs and it is not desirable to attempt to change the jobs after that schedule is set. In this example, on Tuesday the actual jobs for executing the reorganization tasks, the following Sunday, are provided. Another objective of the current invention is to work within this restriction of change management control, while providing the ability to optimally select, balance, and execute the specific tasks within the jobs, in a predetermined job schedule. Copy or backup jobs are typically under this same restriction.

The prior art diagrams the typical approach to running statistics and reorganizing database objects, as well as copying and recovering database objects. Vendors, including IBM, BMC, and others, typically provide computer software for various computing environments, such as an IBM z/OS system and IBM AIX system. These vendors provide routines for a part of the overall set of maintenance tasks, but there are currently no systems available to completely automate these tasks, as they relate to statistics threshold violations, reorganization frequency, copying and recovering database objects, and maintenance window utilization efficiency. The routines from the large vendors include, but are not limited to, statistics routines, reorganization routines, and copy or backup and recovery routines—all of which typically allow wildcard designation of database objects. The wildcarding capability allows multiple objects to be processed with a single task. One problem with this approach is that, from one maintenance cycle to the next, the total amount of data processed can vary significantly. This leads to inefficient and erratic use of a given maintenance window, especially if multiple database administrators have tasks executing in the window.

The current invention automates the generation process for statistics generation, threshold violation detection, reorganization, and copy or backup and recovery tasks. Unlike current vendors, which target individual objects, the current invention analyzes statistics, reorganization, and copy operations from the perspective of a schedule. This inherently maximizes resource utilization in a given maintenance window, which is not currently available in any software package. The current invention is also utility independent. This means that the invention is not dependent on any specific utility vendor. In one embodiment of the current invention, the schedule is built by or materialized by the dynamic generation of a grid of database maintenance tasks. This dynamically generated grid of database maintenance tasks is derived based on capacity of the grid. From a change management perspective, the schedule is a set of tasks that is to be executed at some future time. The current invention's internal representation of a given schedule is the dynamically generated grid of database maintenance tasks.

A database management system, typically called a subsystem for an IBM z/OS or OS/390, or an instance on a distributed platform, may have thousands of database objects, and currently there is no mechanism to automatically generate these reorganization jobs based on statistics threshold violations, or copy and recovery jobs, in a controlled manner. Each organization typically has its own approach to establishing and applying threshold violations, and scheduling reorganization maintenance jobs, as well as copy or backup jobs. An objective of the current invention is to provide a uniform procedure and mechanism for these tasks, so that the resource utilization efficiency of the maintenance window is maximized.

The reorganization effort is typically determined by considering threshold violations from the benchmark statistics. The statistics are obtained for a desired set of objects and ranked according to selected benchmarks. In the current invention, the statistics may be obtained in an efficient manner by running a balanced set of tasks. The results of comparing the statistics to thresholds are used to select a set of tasks to include in a given number of scheduled reorganization jobs. The DBAs are permitted, at any time before the jobs actually run, to assign particular tasks to a job by using selected heuristics from the current invention or by forcing selected objects into the schedule. In this manner, the DBA has control of the reorganization tasks until the jobs are actually started.

Another aspect of the current invention has to do with indexes on partitioned objects. By definition, a partitioned object is an object with at least one index and the object physically exists in multiple partition datasets or files. Indexes on this type of object, exist in two or more forms. First, a partitioning index: where the index object is in the same number of physical datasets as the underlying table, and each index partition indexes the corresponding table partition. Secondly, a non-partitioned index (NPI): where the index is in one physical dataset and indexes the entire table object. Other types of indexes exist on partitioned objects and will be addressed accordingly, as needed. The current invention pays special attention to NPIs. In certain situations, it is desirable to force a reorganization of the non-partitioned index, prior to a reorganization of the partitioned index, if the reorganization is by part or partition. Unlike the prior art, which does not require that the NPI reorganization tasks be done first, the current invention schedules the reorganization of the NPI, prior to other related tasks, for the object. Performing the NPI tasks first can save a substantial amount of time and maintenance window resources.

### SUMMARY OF THE INVENTION

The current invention is a software tool and system that was designed for, and intended to be used by, database administrators (DBAs), who are responsible for maintaining objects in a database environment. The tool consists of both online and batch processes. In one embodiment, the online process comprises a series of visual panels that allow the DBA to define various objects. These visual panels may be presented via either a graphical user interface or a more traditional mainframe user interface. These objects include characteristics of the database objects themselves, as well as definitions of objects required by the tool. The batch processes use the information defined in the online process to dynamically build executable procedures. These procedures and control cards are the resulting artifacts from the dynamically generated grid of database maintenance tasks. These procedures are then executed in a controlled environment, to satisfy the maintenance policies of an organization. The current invention provides a consistent framework that enforces these policies.

The current invention allows database administrators to input object characteristics and constraints, such as the number of concurrent jobs; and to efficiently prioritize, balance, and schedule particular tasks to be run within those predefined jobs.

Balancing and scheduling capabilities are provided for statistics generation and threshold violation analysis, reorganization, and copy or backup tasks. Recovery tasks are automatically generated from these copy tasks.

One aspect of the invention is the ability to dynamically build database utility procedures, in such a way as to distribute objects across concurrent procedures, based on certain criteria or dimensions. The end product is typically a set of procedures, called a schedule, derived from the dynamically generated grid of database maintenance tasks, where each set of procedures process approximately the same amount of data. These procedures coincide with, and are executed by, one or more jobs defined to a job schedule.

There are several benefits of the current invention relative to prior art. All objects are treated the same, using the same criteria. All procedures in the given schedule process approximately the amount of data. The balanced nature of the procedures is a direct result of the dynamically generated grid of database maintenance tasks, which is a core technology of the current invention. Procedures are built and executed in a controlled manner, thereby improving the consistency of procedure scheduling and execution. The user knows what objects will be processed, prior to a maintenance window. The efficiency of the maintenance window is maximized. The schedules can run unattended, if desired.

### BRIEF DESCRIPTION OF THE DRAWINGS—BALANCING AND SCHEDULING DATABASE MAINTENANCE TASKS

FIG. 1 is a flowchart for a typical prior art process for generating and executing database statistics and reorganization jobs.

FIG. 2 is a flowchart for the Generate Statistics step 10 from FIG. 1.

FIG. 3 is a flowchart for the Perform Reorgs step 50 from FIG. 1.

FIG. 4 is a high level flowchart for the current invention that includes populating tool entities, generating statistics and threshold violations, and generating reorganization jobs.

FIG. 5 is a detailed flow chart for Step 100, Populate Tool Entities, of FIG. 4

FIG. 6 is a detailed flow chart for Step 200, Generate Statistics and Threshold Violations, of FIG. 4.

FIG. 7 is a detailed flow chart for Step 300, Perform Reorgs, of FIG. 4.

FIG. 8 is a detailed flow chart for Step 210, Read Group and Statistics Schedule Definition, of FIG. 6.

FIG. 9 is a detailed flow chart for Step 220, Create Extended Object Definitions or Policy for any new objects, of FIG. 6.

FIG. 10 is a detailed flow chart for Step 230, Populate Statistics Entry Entity with job number, of FIG. 6.

FIG. 11 is a detailed flow chart for Step 240, Read Statistics Entry Entity and assign job number, of FIG. 6.

FIG. 12 is a detailed flow chart for Step 250, Generate Statistics Control Cards and Threshold Violation Control Cards, of FIG. 6.

FIG. 13 is a detailed flow chart for Step 260, Generate Executable Procedures or Processes, of FIG. 6.

FIG. 14 illustrates the dynamically balanced statistics schedule generated by Step 260, Generate Executable Procedures or Processes, and processed by Step 270, Execute Statistics and Threshold Violation Jobs, of FIG. 6.

FIG. 15 is a detailed flow chart for Step 310, Read Group and Reorg Schedule Definition, of FIG. 7.

FIG. 16 is a detailed flow chart for Step 320, Create Extended Object Definitions or Policies, of FIG. 7.

FIG. 17 is a detailed flow chart for Step 330, Populate Reorg Entry Entity, of FIG. 7.

FIG. 18 is a detailed flow chart for Step 340, Read Reorg Entry Entity and assign job number, of FIG. 7.

FIG. 19 is a detailed flow chart for Step 350, Generate Reorg Control Cards, of FIG. 7.

FIG. 20 is a detailed flow chart for Step 360, Generate Executable Procedures or Processes, of FIG. 7.

FIG. 21 illustrates the dynamically balanced reorganization schedule generated by Step 360, Generate Executable Procedures or Processes, and processed by Step 370, Execute Reorg Jobs, of FIG. 7.

FIG. 22 is a flowchart for a typical prior art process for generating and executing database copy jobs and generating recovery jobs.

FIG. 23 is a flowchart for the Perform Copy Tasks step 1010 from FIG. 22.

FIG. 24 is a flowchart for the Build Recovery Tasks step 1050 from FIG. 22.

FIG. 25 is a high level flowchart for the current invention that includes populating tool entities, performing copy tasks, and building recovery tasks.

FIG. 26 is a detailed flow chart for Step 1100, Populate Tool Entities, of FIG. 25

FIG. 27 is a detailed flow chart for Step 1200, Perform Copy Tasks and Build Recovery Tasks, of FIG. 25.

FIG. 28 is a detailed flow chart for Step 1210, Read Group and Copy Schedule Definition, of FIG. 27.

FIG. 29 is a detailed flow chart for Step 1220, Create Extended Object Definitions or Policy for any new objects, of FIG. 27.

FIG. 30 is a detailed flow chart for Step 1230, Populate Copy Entry Entity with job number, of FIG. 27.

FIG. 31 is a detailed flow chart for Step 1240, Read Copy Entry Entity and assign job number, of FIG. 27.

FIG. 32 is a detailed flow chart for Step 1250, Generate Copy Control Cards and Recovery Control Cards, of FIG. 27.

FIG. 33 is a detailed flow chart for Step 1260, Generate Executable Copy and Recovery Procedures or Processes, of FIG. 27.

FIG. 34 illustrates the dynamically balanced copy schedule generated by Step 1260, Generate Executable Copy and Recovery Procedures or Processes, and processed by Step 1270, Execute Copy Jobs, of FIG. 27.

FIG. 35 illustrates the dynamically balanced recovery schedule generated by Step 1260, Generate Executable Copy and Recovery Procedures or Processes. These procedures are executed manually as needed or in total in a disaster recovery situation.

FIG. 36 is a table that describes various characteristics of a maintenance policy used by the current invention. Each database object has a unique maintenance policy.

FIG. 37 is a high-level overview of prior art FIG. 1 step 10, Generate Statistics. It shows the typical approach that a group of DBAs would use to generate statistics and threshold violations.

FIG. 38 is a high-level overview of the current invention FIG. 4 step 200, Generate Statistics and Threshold Violations. It shows the approach that that the current invention uses to generate statistics and threshold violations.

FIG. 39 is a high-level overview of prior art FIG. 1 step 50, Perform Reorgs. It shows the typical approach that a group of DBAs would use to generate reorganization jobs.

FIG. 40 is a high-level overview of the current invention FIG. 4 step 300, Perform Reorgs. It shows the approach that that the current invention uses to generate reorganization jobs.

FIG. 41 is a high-level overview of prior art FIG. 22 step 1010, Perform Copy Tasks and step 1050, Build Recovery tasks. It shows the typical approach that a group of DBAs would use to copy or backup objects and build recovery jobs.

FIG. 42 is a high-level overview of the current invention FIG. 25 step 1200, Perform Copy Tasks and Build Recovery Tasks. It shows the approach that that the current invention uses to generate copy or backup jobs and recovery jobs.

### DETAILED DESCRIPTION—PRIOR ART

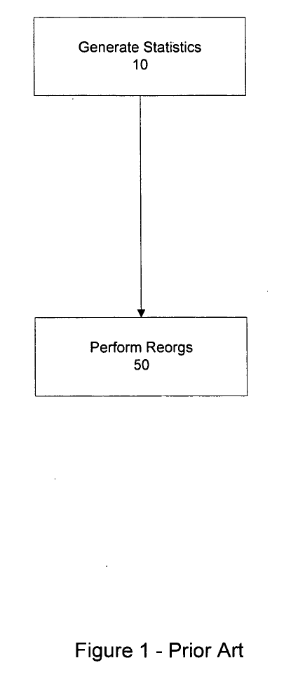

FIG. 1 is a flowchart for a typical prior art process for generating and executing database statistics and reorganization jobs. At step 10, statistics are generated for selected objects. This process is typically manual or semi-automated. At step 50, the reorganization jobs are executed. The main focus of this process is to generate the necessary reorganization jobs and to then execute those jobs. This process is typically manual or semi-automated. Prior art systems typically permit the use of wildcarding object names in both step 10 and step 50.

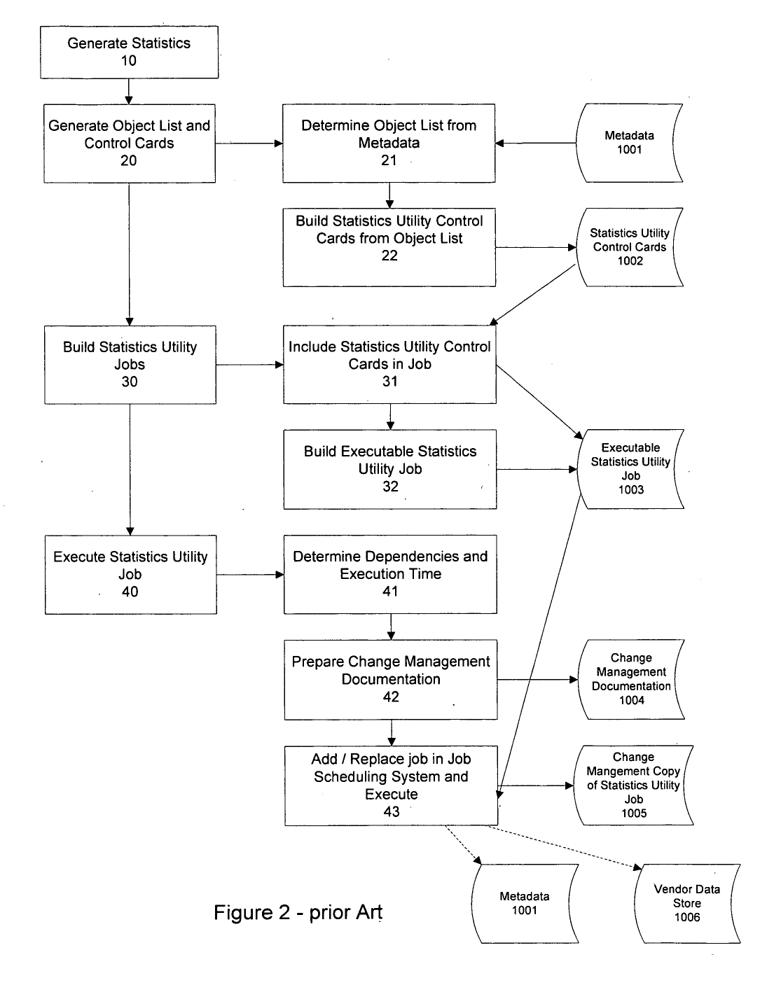

FIG. 2 is a flowchart for the generate statistics step 10 from FIG. 1. At step 20, the object list and control cards are generated. This process determines on what objects to run the statistics utility and builds the necessary control cards required to run the utility. Step 20 includes steps 21 and 22.

Step 21, Determine Object List from Metadata, reads objects from the Metadata 1001. Candidate objects are typically determined based on name. At step 22, Build Statistics Utility Control Cards from Object List, Statistics Control Cards 1002 are formatted, either manually or semi-automatically, and specifications are based on the vendor utility being executed. An example specification would be SHRLEVEL. This data store is populated manually or semi-automatically in the prior art, or fully automatic by the current invention. These control cards are used as input to any statistics utility, and direct the execution of the utility.

At step 30, an Executable Statistics Job data store 1003 is created. This data store is populated manually or semi-automatically in the prior art. Vendor software is available that aid the process of creating a single statistics job. Statistics control cards are used as input to the utility. Step 30 generates the actual job to run the statistics utility. Step 30 includes steps 31 and 32.

Step 31 includes the utility control cards, produced in step 22, as input to the utility, in the executable job. Step 32, Build Executable Statistics Utility Job, builds the required job statements, the Executable Statistics Utility Job data store 1003, that result in the creation of an executable job.

Step 40, the Execute Statistics Utility Job, gets the statistics utility job scheduled and executed. Typically, a decision is made as to when the utility should execute and documentation is created to convey that information to a Change Management Group. Step 40 includes steps 41, 42 and 43.

Step 41, Determine Dependencies and Execution Time, which is typically manual, analyzes existing scheduled jobs or events to determine dependencies and when the utility should execute. An example of a dependency might be an application-related job that updates the object. An example of when to execute the utility might be down time for an application that references the object. Step 42, Prepare Change Management Documentation, compiles and produces the documentation required to get the executable job scheduled in the environment's job scheduling system. The Statistics Change Management Documentation data store 1004 is populated manually or semi-automatically by in-house or vendor software. Document content consists of specifics of day and time the job executes, dependencies, and location of all pieces of the executable package. Step 43, Add/Replace Job in Job Scheduling System and Execute, permits adding or replacing the job, in the job scheduling system defined libraries or directories; and adding or replacing the day and time definitions, including any and all dependencies, for the job, in the job scheduling system. Actual execution of the utility will result in the metadata being updated, and possibly vendor supplied data stores, being updated. Step 43 typically updates Metadata 1001; the Change Management Copy of Statistics Utility Job data store 1005 which comprises the executable pieces of the package, and is populated by the organization's change management team; and Vendor Data Store 1006. This data store exists if an organization has vendor software that augments the statistics and/or reorganization generation process. Examples of this data store are vendor threshold violation entities or proprietary entities. Not all vendors provide these entities or processes. The current invention fills in gaps created by not having currently available vendor software.

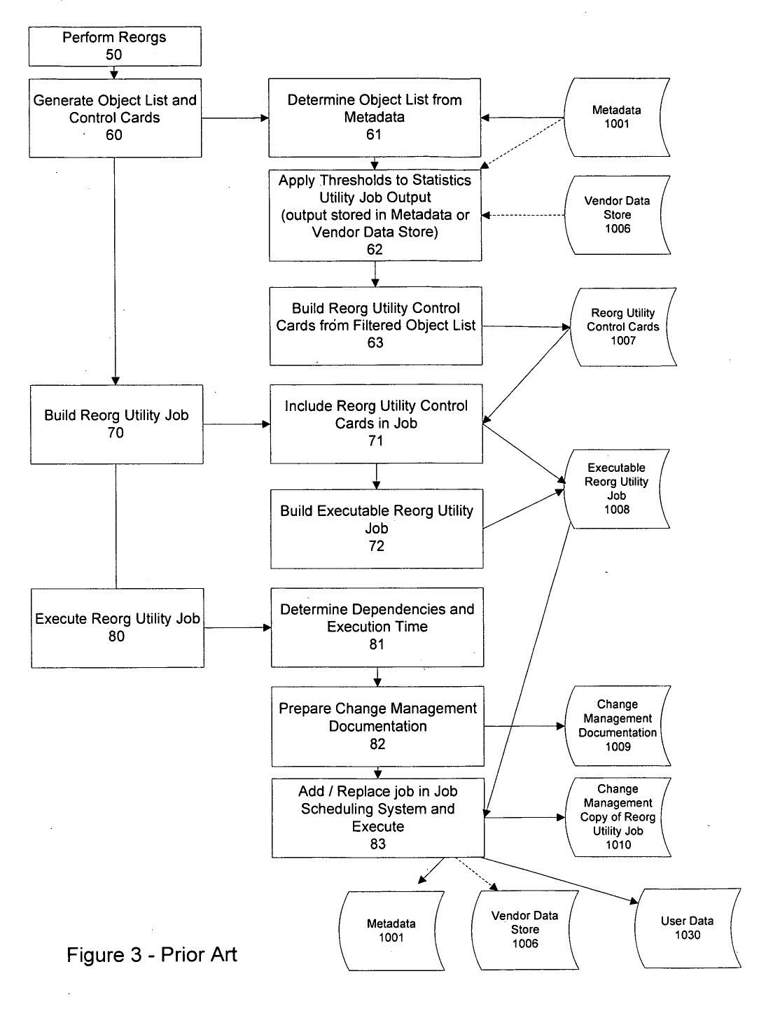

FIG. 3 is a flowchart for the Perform Reorgs step 50 from FIG. 1. Step 60, generate Object List and Control Cards, determines on what objects to run the reorg utility and builds the necessary control cards required to run the utility. Step 60 includes . steps 61, 62 and 63.

Step 61, Determine Object List from Metadata reads objects from the metadata. Candidate objects are typically determined based on name. Step 62, Apply Thresholds to Statistics Utility Job Output, applies all thresholds, thereby creating a second and final list, or filtered list. Typically thresholds are minimum or maximum values for characteristics like cluster ratio and number of extents. At step 63, Build Reorg Utility Control Cards from Filtered Object List, the control cards are formatted, either manually or semi-automatically, based on the list from step 62, and stored in the Reorg Utility Control Cards data store 1007.

Step 70, Build Reorg Utility Job, generates the actual job to run the reorg utility. Step 70 includes steps 71 and 72.

Step 71, Include Reorg Utility Control Cards in Job, includes the utility control cards, from step 63, as input to the utility, in the executable job. Step 72, Build Executable Reorg Utility Job, builds the required job statements that result in the creation of an Executable Reorg Job data store 1008. This data store is populated manually or semi-automatically in the prior art. Vendor software is available that aid the process of creating a single reorganization job. Reorg control cards are used as input to the utility.

Step 80, Execute Reorg Utility Job, gets the reorg utility job scheduled and executed. Typically, a decision is made as to when the utility should execute and documentation is created to convey that information to a Change Management Group. Step 80 includes steps 81, 82 and 83.

At step 81, the Determine Dependencies and Execution Time process is typically manual and involves analysis of existing scheduled jobs or events, to determine dependencies and when the utility should execute. An example of a dependency might be a weekly backup or copy job. An example of when to execute the utility might be down time for an application that references the object. Step 82, Prepare Change Management Documentation, compiles and produces the documentation required to get the executable job scheduled in the environment's job scheduling system. Step 82 populates the Reorg Change Management Documentation data store 1009 manually or semi-automatically by in-house or vendor software. Document content consists of specifics of day and time the job executes, dependencies, and location of all pieces of the executable package. Step 83, Add/Replace Job in Job Scheduling System and Execute, adds or replaces the job in the job scheduling system defined libraries or directories; and adds or replaces the day and time definitions, including any and all dependencies, for the job, in the job scheduling system. Actual execution of the utility will result in the User Data data store 1030 being reorganized, Metadata 1001 being updated, and possibly a Vendor Data Store 1006, being updated. In step 83, the Change Management Copy of Reorg Utility Job data store 1010 is populated by an organization's change management team. This data store consists of the executable pieces of the package.

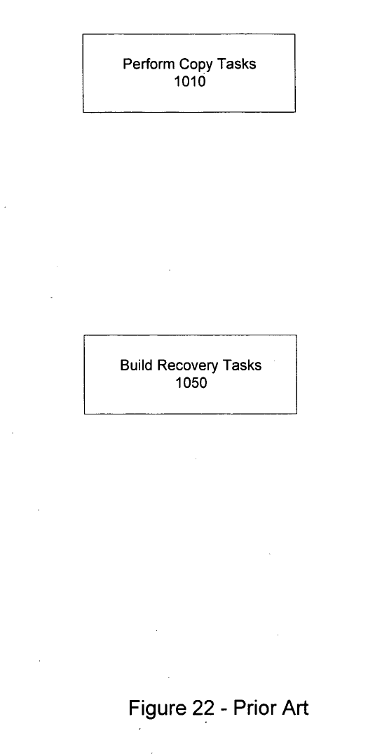

FIG. 22 is a flowchart for a typical prior art process for generating and executing database copy jobs and generating recovery jobs. A step 1010, copy tasks are generated and executed for selected objects. This process is typically manual or semi-automated. At step 1050, the recovery jobs are created. The main focus of this process is to generate the necessary recovery jobs. This process is typically manual or semi-automated. Prior art systems typically permit the use of wildcarding object names in both step 1010 and step 1050.

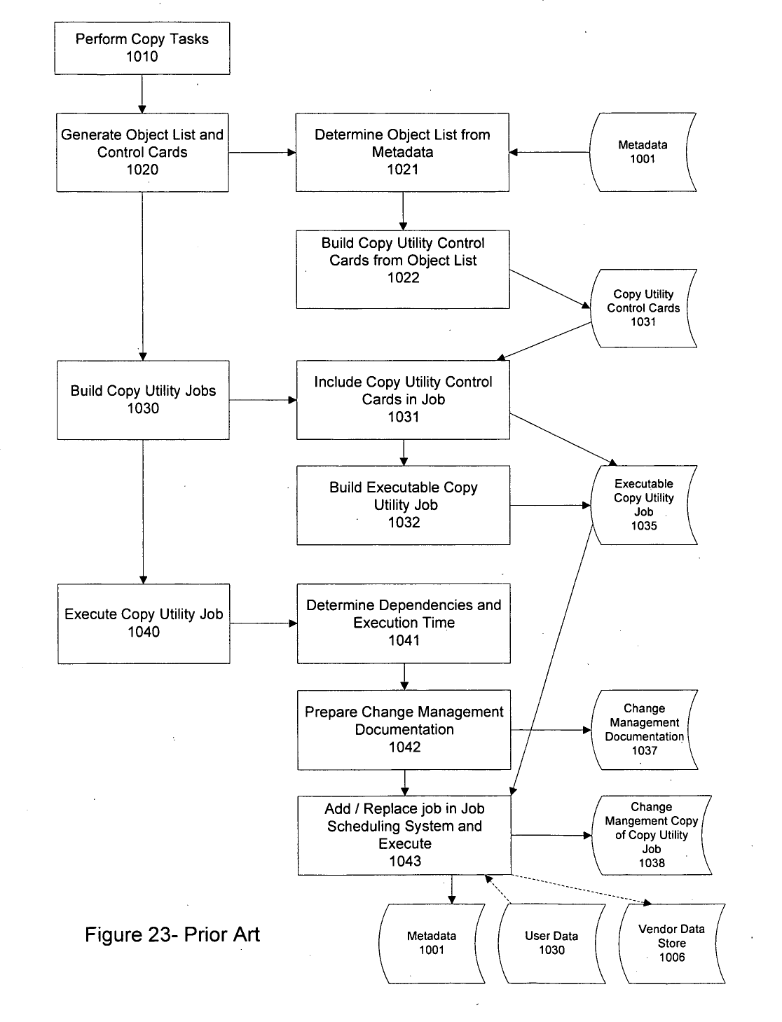

FIG. 23 is a flowchart for the perform copy tasks step 1010 from FIG. 22. At step 1020, the object list and control cards are generated. This process determines on what objects to run the copy utility and builds the necessary control cards required to run the utility. Step 1020 includes steps 1021 and 1022.

Step 1021, Determine Object List from Metadata, reads objects from the Metadata 1001. Candidate objects are typically determined based on name. At step 1022, Build Copy Utility Control Cards from Object List, Copy Utility Control Cards 1031 are formatted, either manually or semi-automatically, and specifications are based on the vendor utility being executed. An example specification would be SHRLEVEL. This data store is populated manually or semi-automatically in the prior art, or fully automatic by the current invention. These control cards are used as input to any copy utility, and direct the execution of the utility.

At step 1030, an Executable Copy Utility Job data store 1035 is created. This data store is populated manually or semi-automatically in the prior art. Vendor software is available that aid the process of creating a single copy job. Copy control cards are used as input to the utility. Step 1030 generates the actual job to run the copy utility. Step 1030 includes steps 1031 and 1032.

Step 1031 includes the utility control cards, produced in step 1022, as input to the utility, in the executable job. Step 1032, Build Executable Copy Utility Job, builds the required job statements, the Executable Copy Utility Job data store 1035, that result in the creation of an executable job.

Step 1040, the Execute Copy Utility Job, gets the copy utility job scheduled and executed. Typically, a decision is made as to when the utility should execute and documentation is created to convey that information to a Change Management Group. Step 1040 includes steps 1041, 1042 and 1043.

Step 1041, Determine Dependencies and Execution Time, which is typically manual, analyzes existing scheduled jobs or events to determine dependencies and when the utility should execute. An example of a dependency might be an application-related job that updates the object. An example of when to execute the utility might be down time for an application that references the object. Step 1042, Prepare Change Management Documentation, compiles and produces the documentation required to get the executable job scheduled in the environment's job scheduling system. The Copy Change Management Documentation data store 1037 is populated manually or semi-automatically by in-house or vendor software. Document content consists of specifics of day and time the job executes, dependencies, and location of all pieces of the executable package. Step 1043, Add/Replace Job in Job Scheduling System and Execute, permits adding or replacing the job in the job scheduling system defined libraries or directories; and adding or replacing the day and time definitions, including any and all dependencies, for the job, in the job scheduling system. Actual execution of the utility will result in the metadata being updated, user data being copied, and possibly vendor supplied data stores being updated. Step 1043 typically updates Metadata 1001; the Change Management Copy of Copy Utility Job data store 1038 which comprises the executable pieces of the package, and is populated by the organization's change management team; and Vendor Data Store 1006. This data store exists if an organization has vendor software that augments the copy generation process. The current invention fills in gaps created by not having currently available vendor software.

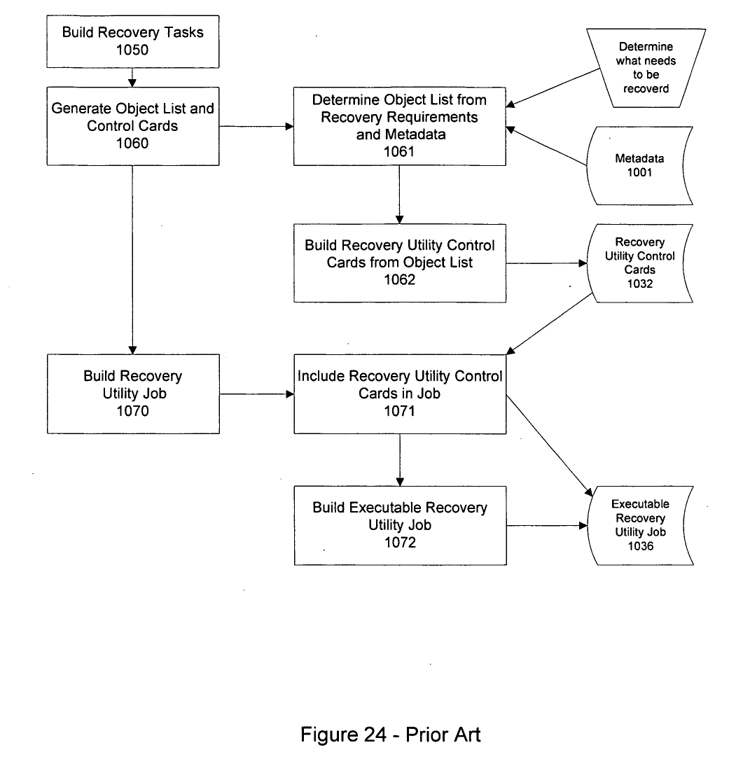

FIG. 24 is a flowchart for the Build Recovery Tasks step 1050 from FIG. 22. Step 1060, generate Object List and Control Cards, determines on what objects to run the recovery utility and builds the necessary control cards required to run the utility. Step 1060 includes steps 1061 and 1062.

Step 1061, Determine Object List from Recovery Requirements and Metadata is where the DBA determines what objects need to be recovered, and then reads objects from the metadata. Candidate objects are typically determined based on name. Step 1062, Build Recovery Utility Control Cards from Object List, the control cards are formatted, either manually or semi-automatically, based on the list from step 1061, and stored in the Recovery Utility Control Cards data store 1032. This data store is populated manually or semi-automatically in the prior art, or fully automatic in the current invention.

Step 1070, Build Recovery Utility Job, generates the actual job to run the recovery utility. Step 1070 includes steps 1071 and 1072.

Step 1071, Include Recovery Utility Control Cards in Job, includes the utility control cards, from step 1062, as input to the utility, in the executable job. Step 1072, Build Executable Recovery Utility Job, builds the required job statements that result in the creation of an Executable Recovery Job data store 1036. This data store is populated manually or semi-automatically in the prior art. Vendor software is available that aid the process of creating a single recovery job. Recovery control cards are used as input to the utility. At this point, the recovery job and recovery control cards have been created for the given object(s).

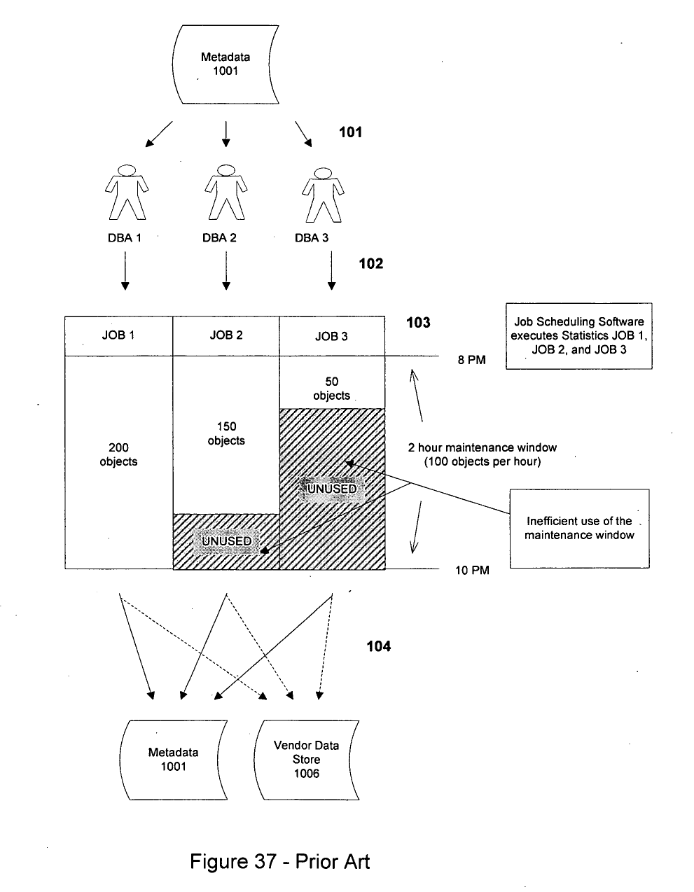

FIG. 37 is a high-level overview of prior art FIG. 1 step 10, Generate Statistics. It shows the typical approach that a group of DBAs would use to generate statistics and threshold violations. In this example: DBA1 has 400 objects and uses JOB1, DBA2 has 150 objects and uses JOB2, and DBA3 has 50 objects and uses JOB3. At 101, each DBA would select database objects from the candidate objects he or she supports, which are to be included in the statistics and threshold violation jobs. Each DBA typically creates his own job. At 102, each DBA would then physically add the object to the job. At 103, typically a job-scheduling product would execute the previously built statistics and threshold violation jobs. At 104, the executed jobs would gather statistics and generate threshold violations for each of the objects. Statistics are written to the Metadata 1001 and threshold violations are written to the Vendor Data Store 1006. The main problems with this approach are 1) DBA1 can only schedule 200 objects (100 objects and hour and a two hour window), 2) there is significant manual effort involved in configuring the jobs, and 3) the maintenance window overall is underutilized since JOB2 and JOB3 could do more work

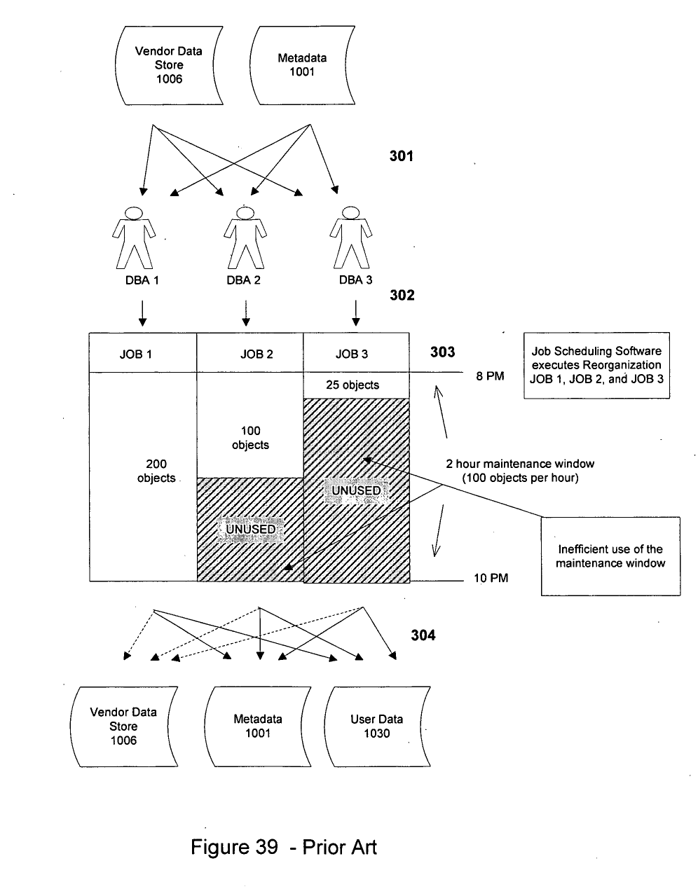

FIG. 39 is a high-level overview of prior art FIG. 1 step 50, Perform Reorgs. It shows the typical approach that a group of DBAs would use to generate reorganization jobs. In this example: DBA1 has 400 objects and uses JOB1 with 250 objects needing reorganization, DBA2 has 150 objects and uses JOB2 with 100 objects needing reorganization, and DBA3 has 50 objects and uses JOB3 with 25 objects needing reorganization. At 301, each DBA would select database objects from the candidate objects he or she supports, which are to be included in the reorganization jobs. This selection is typically based on threshold violations. Each DBA typically creates his own job. At 302, each DBA would then physically add the object to the job. At 303, typically a job-scheduling product would execute the previously built reorganization jobs. At 304, the executed jobs would reorganize each of the objects. The Metadata 1001 is updated to reflect the reorganizations, as well as the Vendor Data Store 1006, if used. The User Data 1030 is reorganized. The main problems with this approach are 1) DBA1 can only schedule 200 objects (100 objects and hour and a two hour window), 2) there is significant manual effort involved in configuring the jobs, and 3) the maintenance window overall is underutilized since JOB2 and JOB3 could do more work.

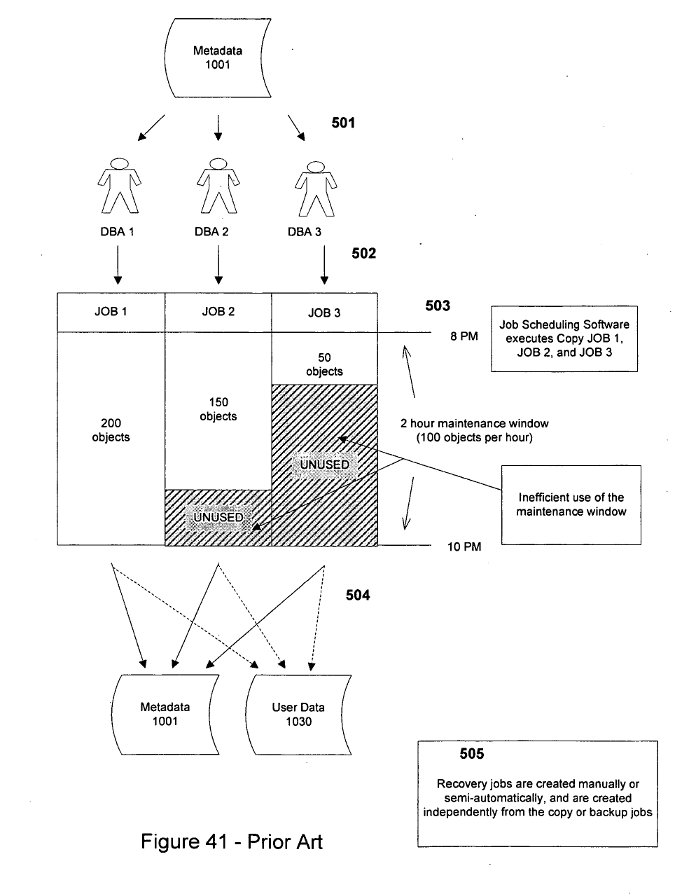

FIG. 41 is a high-level overview of prior art FIG. 22 step 1010, Perform Copy Tasks and step 1050, Build Recovery tasks. It shows the typical approach that a group of DBAs would use to copy or backup objects and build recovery jobs. In this example: DBA1 has 400 objects and uses JOB1, DBA2 has 150 objects and uses JOB2, and DBA3 has 50 objects and uses JOB3. At 501, each DBA would select database objects from the candidate objects he or she supports, which are to be included in the copy jobs. Each DBA typically creates his own job. At 502, each DBA would then physically add the object to the job. At 503, typically a job-scheduling product would execute the previously built copy jobs. At 504, the executed jobs would copy or backup each of the objects. Recovery jobs for the objects included in the copy jobs, are typically an afterthought and are not generally created unless they are required. The Metadata 1001 is updated to reflect the copy or backup. The User Data 1030 is copied. At 505, which is typically an afterthought, recovery jobs are created, but only if required. The main problems with this approach are 1) DBA1 can only schedule 200 objects (100 objects and hour and a two hour window), 2) there is significant manual effort involved in configuring the jobs, and 3) the maintenance window overall is underutilized since JOB2 and JOB3 could do more work.

### DETAILED DESCRITPION OF EMBODIMENT—BALANCING AND SCHEDULING DATABASE MAINTENANCE TASKS

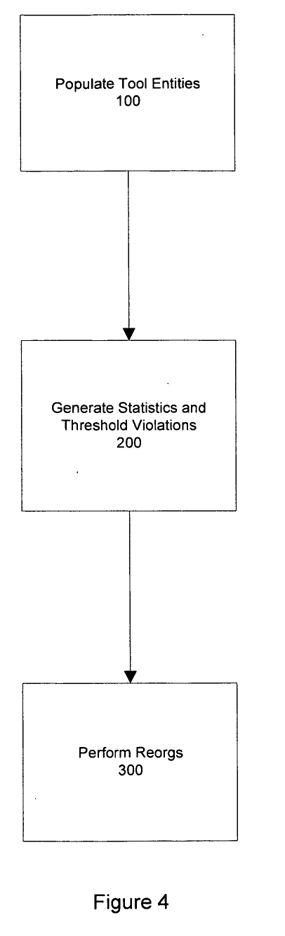

FIG. 4 is a high level flowchart for the current invention that includes populating tool entities, generating statistics and threshold violations, and generating reorganization jobs. At Step 100, Populate Tool Entities, an online process allows the database administrator to define various entities required by the tool, and to define characteristics of the database objects themselves. Additionally, the database administrator can include, or force, objects that would not otherwise be part of a utility schedule. Similarly, the database administrator can exclude, or force, objects out of a utility schedule, if necessary.

At step 200, the Generate Statistics and Threshold Violations core process determines whether or not an object is triggered for reorg. Initially, statistics are gathered for the object, by any vendor routine. Once gathered, the statistics are analyzed to apply the organization's threshold violation criteria. If violations are detected, this information is written to a repository. This repository is referenced later in the overall process, to determine if a reorg of the object is necessary. This process is executed based on a group and schedule number.

At step 300, Perform Reorgs, a core process generates and executes the reorg jobs. One major aspect of the current invention, as it relates to gathering statistics, generating threshold violations, and the resulting reorganization tasks, is the coupling or seamless integration of steps 200 and 300. DBA groups typically spend a significant amount of manual effort deciding what objects to reorganize based on several factors including but not limited to, threshold violations, importance of the object, and time constraints of the maintenance window. The current invention makes objective decisions about what to reorganize, thereby replacing the typical subjective and manually intensive approach.

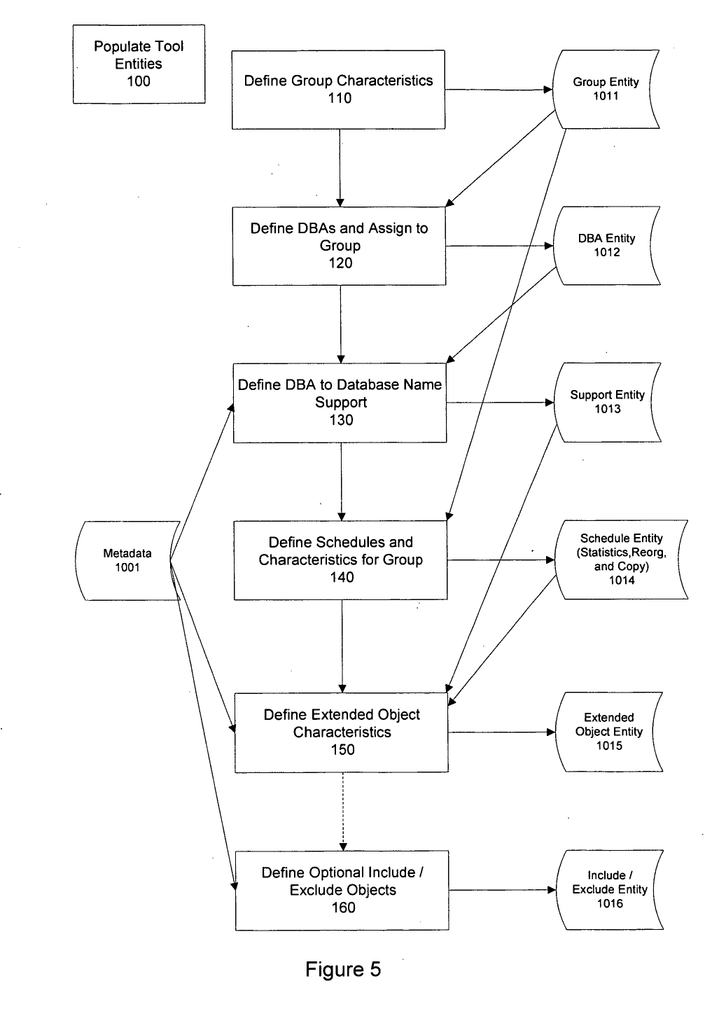

FIG. 5 is a detailed flow chart for Step 100, Populate Tool Entities, of FIG. 4. Step 110, Define Group Characteristics, allows the DBA to define characteristics of the Group entity 1011. The Group Entity data store 1011 is the highest-level entity required by the current invention. The entity represents a technical group, or a team of people, responsible for managing database objects. Examples of a group would be a production support DBA group, a systems administration DBA group, or a test DBA group. Characteristics of the Group entity data store comprise a group number, a description, default statistics schedule number, default reorg schedule number, default copy schedule number, a product load library name or path name, a user load library name or path name, an optional attach name and high-level qualifier, a last update userid, and last update timestamp. Other characteristics may be included. These characteristics are platform independent.

Step 120, Define DBAs and Assign to Group, allows the DBA to define DBA userids to a group. This process directly ties a DBA to a group. The DBA Entity data store 1012 represents an individual database administrator (DBA). Characteristics of the DBA entity comprise a userid, a group number (used to tie the DBA entity to the Group entity), and contact information that may include phone number, pager number, email address, among others. Other characteristics may also be included. These characteristics are platform independent. For distributed platforms like UNIX and Windows: the userid value would most likely be the instance owner id.

Step 130, Define DBA to Database Name Support, allows the DBA to define the relationship between DBA userids and database names. Indirectly, this ties a database name to a group, via the DBA entity. The Support Entity data store 1013 represents a relationship between a DBA entity and a database name. Once created, there is an implicit relationship between a database name and a group, via the DBA entity. Hence, a database is supported by only one group. Characteristics of the Support entity comprise a database name, a userid (from the DBA entity), a last update userid, and a last update timestamp. Other characteristics may also be included. These characteristics are platform independent. For host platforms like OS/390 or z/OS: the database name value could be any user database. For distributed platforms like UNIX or Windows: the database name value would be any database name in the database management instance.

Step 130 reads the Metadata data store 1001 which comprises object definitions, including table definitions, column definitions, view definitions, authorization definitions, and others. This repository is usually referred to as the system catalog, and is the main repository for database management systems such as DB2, Oracle, and others.

Step 140, Define Schedules and Characteristics for Group, allows the DBA to define schedules and characteristics of those schedules, for the group. The Schedule Entity data store 1014 represents a utility schedule for a group. In this embodiment, this entity has three types-Statistics, Reorg, and Copy. Other schedule types may be added as needed. In this embodiment, a group can have up to 99 schedules for each schedule type. Characteristics of the Schedule entity comprise a schedule number, a schedule type, a group number, a description, the number of concurrent jobs, a procedure library or path name, a control card library or path name, a share level for the schedule, a procedure or process name for the utility, the utility vendor, a procedure or process prefix, a procedure or process suffix, threshold specifications, various utility-specific parameters, a last update userid, and a last update timestamp. Other characteristics may also be included. These characteristics are platform independent. A key characteristic of each schedule is the number of concurrent jobs allowed. This provides the basis for the balancing function. Other example characteristics are repository names for procedures and control cards. These repository names can be libraries or directories.

Step 150, Define Extended Object (Policies) Characteristics, allows the DBA to define extended characteristics of database objects. Examples include job numbers for statistics, reorg, and copy processes. If these job numbers are left at the default value of zero, the object is placed in a specific job based on the dynamic balancing process. If nonzero values are supplied, the object is placed in that job. The object definition allows for job numbers for each schedule type. This means that the user can force statistics to be in job 3, while the reorg process for the object, using job 0, will result in the object being dynamically balanced into a job.

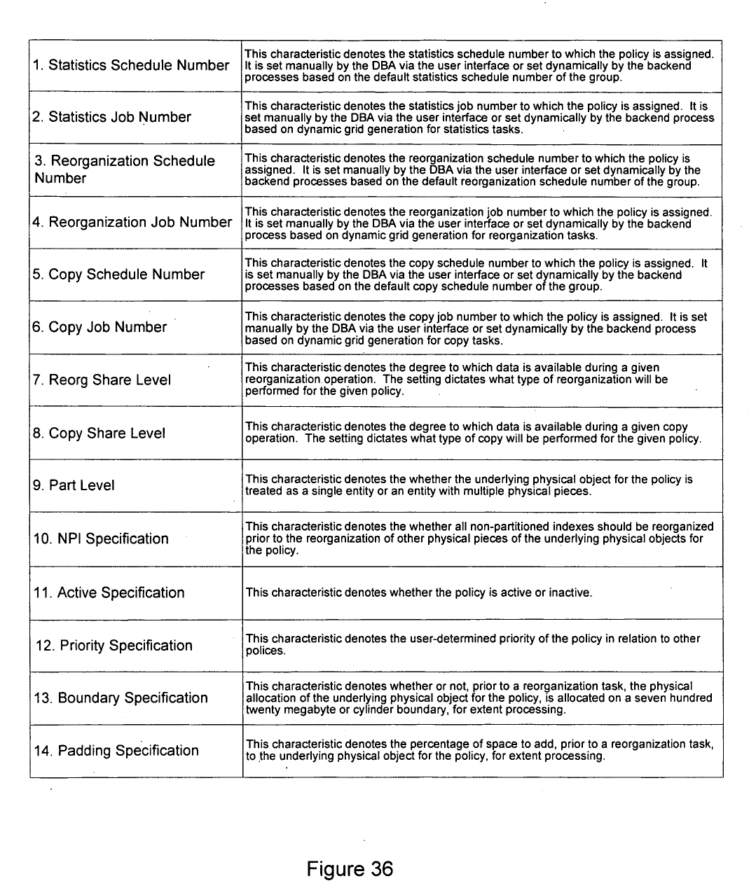

The Extended Object Entity data store 1015 represents an extended definition of an object. An extended definition is defined as characteristics required by or implemented by the tool that do not exist in the database management system metadata 1001 system catalog. Characteristics of the Extended Object entity comprise an object name, a statistics schedule number, a reorg schedule number, up to five copy schedule numbers, a forced reorg schedule job number, up to five forced copy schedule job numbers, a share level specification, a part level specification, an active/inactive specification, an non-partitioned index specification, an allocation cushion specification, a last update userid, and a last update timestamp. Other characteristics may also be included. These characteristics are platform independent. These characteristics are defined in FIG. 36. Other characteristics may be added as appropriate. Each database object has a unique maintenance policy.

Step 160, Define Optional Include/Exclude Objects, is optional and allows the DBA to force an object into a given reorg schedule. The main purpose for this process is to include the reorg of an object to occur, even though there were no threshold violations for the object. An example of why this process might be used is to physically move the object from one disk array or DASD device to another. The Include/Exclude Entity data store 1016 is an optional entity which is provided so that an object can be forced, either included into or excluded from, a reorg schedule. The entity represents a forced object. Characteristics of the Include/Exclude entity comprise an object name, an include or exclude specification, an optional allocation specification, a beginning and ending date range denoting the time period the specification is to be honored, a last update userid, and a last update timestamp. Other characteristics may also be included. These characteristics are platform independent.

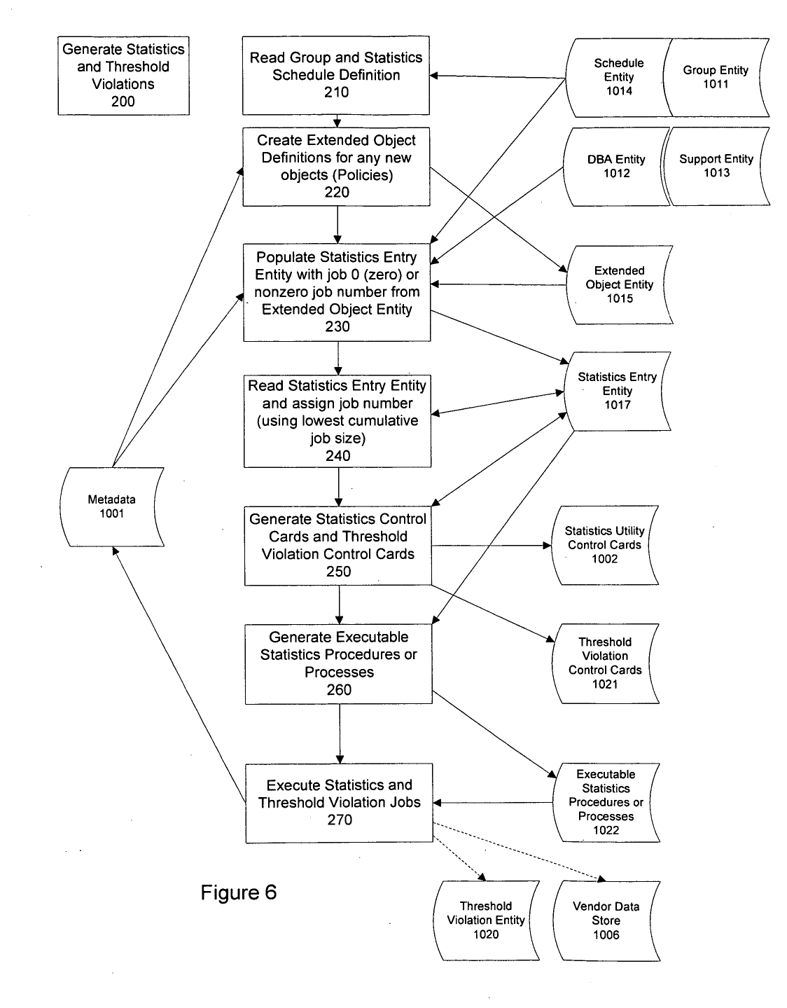

FIG. 6 is a detailed flow chart for Step 200, Generate Statistics and Threshold Violations, of FIG. 4. Step 210, Read Group and Statistics Schedule Definition, is executed by the batch, or backend, task. Characteristics of the group and statistics schedule are used to determine processing requirements. Step 210 uses information from the Schedule Entity data store 1014 and the Group Entity data store 1011.

Step 220, Create Extended Object Definitions or Policies for any new objects, is executed by the batch, or backend task. This step automatically defines Extended Object Entity Definitions or Policies 1015, with default characteristics, for any new objects that were not previously defined in the tool.

Step 230, Populate Statistics Entry Entity with job number, reads all objects tied to the group and that are defined to use the statistics schedule in progress. Objects are read from the Metadata based on group/schedule/DBA/support/size and priority. Size is determined by, but not limited to, any of the following: number of active pages; current physical allocation; or 3) row length of the objects multiplied by the number of rows in the table(s). Other dimensions could also be used to denote size of an object. Priority is optionally assigned by the user based on the objects' importance to the enterprise. The process defines instances of a new entity, or Statistics Entry for each object. A job value or 0 (zero) or the statistics job number from the Object Entity are used. A job value of 0 (zero) indicates the use of the dynamic balancing method. A nonzero value dictates a forced placement into a specific job. This step reads information from Group Entity data store 1011, Schedule Entity data store 1014, DBA Entity data store 1012, and Support Entity data store 1013.

In this embodiment, the Statistics Entry Entity data store 1017 is populated internally. The entity represents an object entry in a statistics schedule. Characteristics of the Statistics Entry entity comprise an object name, a job number, the physical size of the object, control card file name(s), a last update userid, and a last update timestamp, among others. Other characteristics may also be included.

Step 240, Read Statistics Entry Entity and assign job number, comprises the core balancing method of the current embodiment. As each row of the Statistics Entry data store 1017 for this group and schedule are read, a job number is assigned if the initial job number is 0 (zero). To determine in which job the object is placed, a cumulative job size, for each job, is maintained. As each row of the Statistics Entry is read, the cumulative job size, for each job, is reviewed. The job number in the Statistics Entry is modified to reflect the job number with the lowest cumulative job size. If, however, the Statistics Entry job number is nonzero, the object is placed in that specific job. In either case, the cumulative job size is updated to reflect the addition of the object into the job.

Step 250, Generate Statistics Control Cards and Threshold Violation Control Card, reads the updated Statistics Entry 1017 objects, for the group and schedule, and generates the necessary statistics and threshold violation control cards, based on what vendor utility is being used. These control cards are written to a repository for later processing. The Statistics Control Cards data store 1002 and Threshold Violation Control Cards data store 1021 are populated automatically by the current invention. These control cards are used as input to any statistics utility, and direct the execution of the utility.

At Step 260, Generate Executable Procedures or Processes, reads the updated Statistics Entry 1017 objects, for the group and schedule, and generates the necessary statistics and threshold violation job procedures or processes, based on what vendor utility is being used. These job procedures or processes are written to a repository for later processing. The Executable Statistics Procedures or Processes data store 1022 is populated automatically by the current invention. The procedures or processes make up the executable portion of the statistics maintenance effort. Logically, the procedures or processes appear as a grid of individual statistics utility tasks. Each procedure or process is executed by, or invoked from, a calling job or shell. Together, the procedures inherently maximize resource efficiency in the maintenance window.

At Step 270, the Execute Statistics and Threshold Violation Jobs process gathers statistics, writes them to the metadata repository 1001 and/or vendor repository and then applies established thresholds, defined in the Schedule Entity data store 1014 to further generate threshold violation details. These details are written to a vendor repository 1006 or to the Violation Entity 1020, defined in the tool. The Vendor Data Store 1006 exists if an organization has vendor software that augments the statistics and/or reorganization generation process. Examples of this data store are vendor threshold violation entities or proprietary entities. Not all vendors provide these entities or processes. The current invention fills in gaps created by not having currently available vendor software. The Threshold Violation Entity data store 1020 is populated internally by the current invention if an organization does not posses a vendor routine that creates threshold violations. The entity represents a threshold violation, for a given object, that participated in a statistics schedule. Characteristics of the Threshold Violation entity include, but are not limited to: an object name, a threshold name or category, a threshold value, a violation value, and a timestamp, among others. In this example, the Threshold Violation Entity data store 1020 provides the basis for determining candidate objects for reorganization. The current invention automatically generates reorganization tasks, based on this data store. Furthermore, the resulting balanced schedule of reorganization tasks, maximize resources in the maintenance window. In the prior art, the vendor data store entries are possibly generated, but the dynamic generation of reorganization jobs, is currently not supported by any vendor, nor does any vendor attempt to create a balanced set of tasks, focusing on maximizing maintenance window resources.

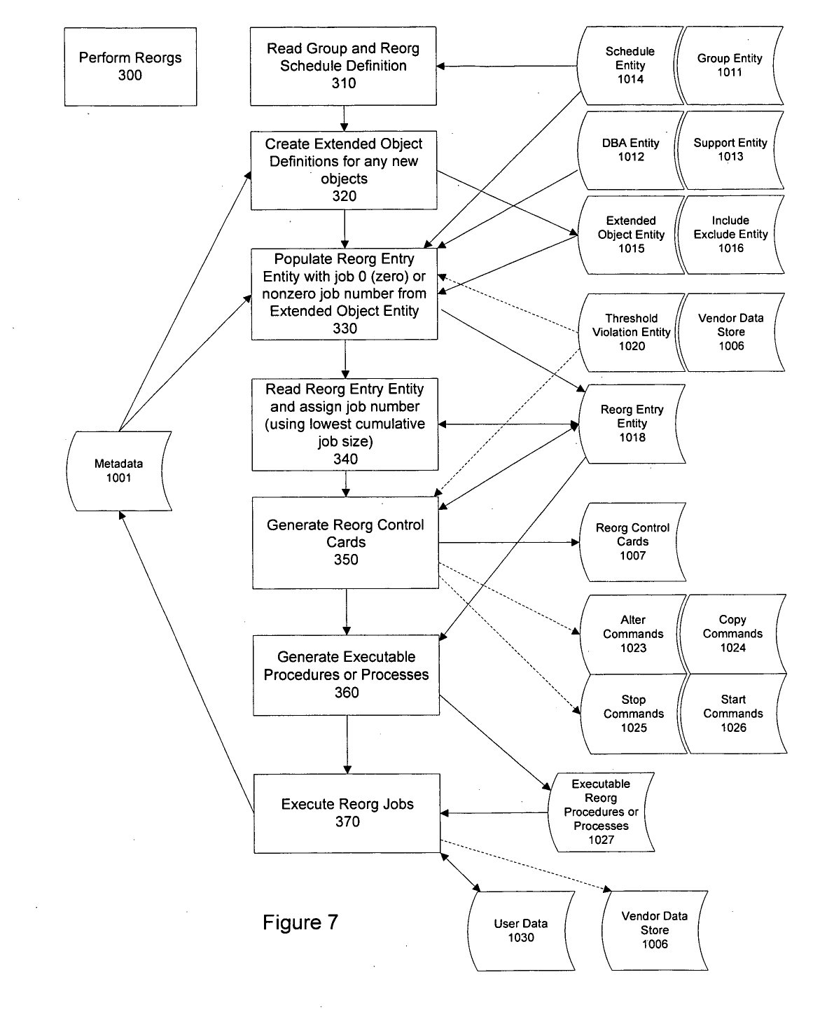

FIG. 7 is a detailed flow chart for Step 300, Perform Reorgs, of FIG. 4. At Step 310, the Read Group and Reorg Schedule Definition process is executed by the batch, or backend, task. Characteristics of the group and reorg schedule are used to determine processing requirements.

At Step 320, the Create Extended Object Definitions or Policies for any new objects process is executed by the batch, or backend, task. This step automatically defines Extended Object Entity Definitions or Policies 1015, with default characteristics, for any new objects that were not previously defined in the tool.

At Step 330, the Populate Reorg Entry Entity with job number process reads all objects tied to the group and that are defined to use the reorg schedule in progress. Objects are read from the Metadata 1001 based on group/schedule/DBA/support/size. Size is determined by, but not limited to, any of the following: number of active pages, current physical allocation, or row length of the objects multiplied by the number of rows in the table(s). The process defines instances of a new entity, or Reorg Entry for each object. A job value or 0 (zero) or the reorg job number from the Object Entity are used. A job value of 0 (zero) indicates the use of the dynamic balancing method. A nonzero value dictates a forced placement into a specific job.

This step also references the Extended Object Entity data store 1015, for each object read from the Metadata data store 1001. Additional filtering is applied by reading the Include/Exclude Entity data store 1016, to check if the current object should be included into, or excluded from, the reorg schedule being generated.

The Reorg Entry Entity data store 1018 is populated internally in this embodiment. The entity represents an object entry in a reorg schedule. Characteristics of the Reorg Entry entity include, but are not limited to: an object name, a job number, the physical size of the object, an active/inactive specification, control card file name(s), a last update userid, and a last update timestamp, among others.

At Step 340, the Read Reorg Entry Entity and assign job number process comprises the core balancing method of the current embodiment. As each Reorg Entry, for this group and schedule, are read, a job number is assigned, if the initial job number is 0 (zero). To determine in which job the object is placed, a cumulative job size, for each job, is maintained. As each Reorg Entry is read, the cumulative job size, for each job, is reviewed. The job number in the Reorg Entry is modified to reflect the job number with the lowest cumulative job size. If, however, the Reorg Entry job number is nonzero, the object is placed in that specific job. In either case, the cumulative job size is updated to reflect the addition of the object into the job.

At Step 350, the Generate Reorg Control Cards process reads the updated Reorg Entry objects data store 1018 and generates the necessary reorg control cards, based on what vendor utility is being used. These control cards are written to a repository for later processing. Alter, Copy, Stop, and Start commands may also be generated in this process. These latter commands are generated only on certain platforms. The Reorg Utility Control Cards data store 1017 is populated automatically by the current invention. These control cards are used as input to any reorg utility, and direct the execution of the utility.

The Alter Commands data store 1023 is populated automatically by the current invention. These commands are generated if an object has an extent number violation, that warrants increasing the size of the object. The current invention calculates the new size of an object based on current size, number of extents, and a user-supplied padding value. These commands are generated only on z/OS or OS/390 platforms.

The Copy Commands data store 1024 is populated automatically by the current invention. These commands are generated if an object requires a copy or backup, and the copy or backup was unable to be taken during the reorganization process. These commands are generated only on z/OS or OS/390 platforms.

The Stop Commands data store 1025 is populated automatically by the current invention. These commands are generated if certain physical characteristics of an object are changed. Start and Stop commands work as a pair, for a given object. These commands are generated only on z/OS or OS/390 platforms.

The Start Commands data store 1026 is populated automatically by the current invention. These commands are generated if certain physical characteristics of an object are changed. Start and Stop commands work as a pair, for a given object. These commands are generated only on z/OS or OS/390 platforms.

At Step 360, Generate Executable Procedures or Processes reads the updated Reorg Entry objects data store 1018 and generates the necessary reorg job procedures or processes, based on what vendor utility is being used. These job procedures or processes are written to a repository for later processing. This step is responsible for generating procedures or processes based on specific vendor utility routines. In other words, the generated tasks reflect the vendor routine that an organization uses.

The Executable Reorg Procedures or Processes data store 1027 is populated automatically by the current invention. The procedures or processes make up the executable portion of the statistics maintenance effort. Logically, the procedures or processes appear as a grid of individual statistics utility tasks. Each procedure or process is executed by, or invoked from, a calling job or shell. Together, the procedures inherently maximize resource efficiency in the maintenance window.

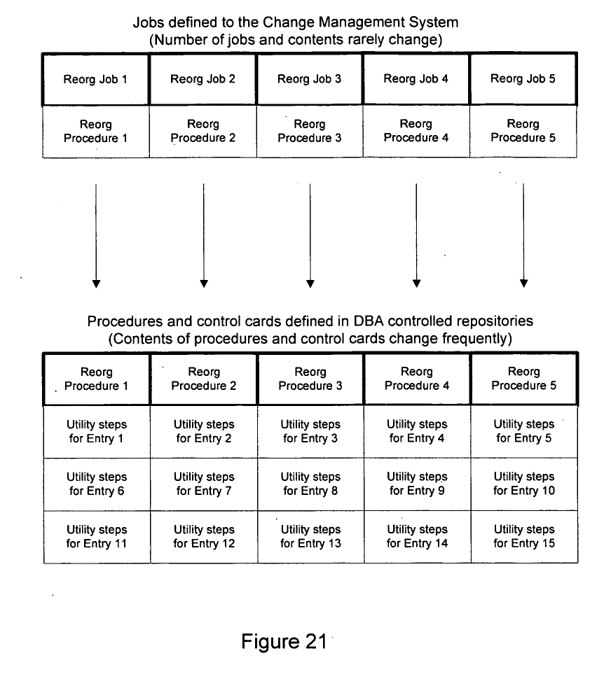

At Step 370, the Execute Reorg Jobs process executes the combined reorg jobs. The User Data data store 1030 represents any user data generated and maintained by an organization. This data is the target of the statistics, reorganization, and copy or backup effort. FIG. 21 illustrates the dynamically balanced reorganization schedule generated by Step 360, Generate Executable Procedures or Processes, and processed by Step 370, Execute Reorg Jobs.

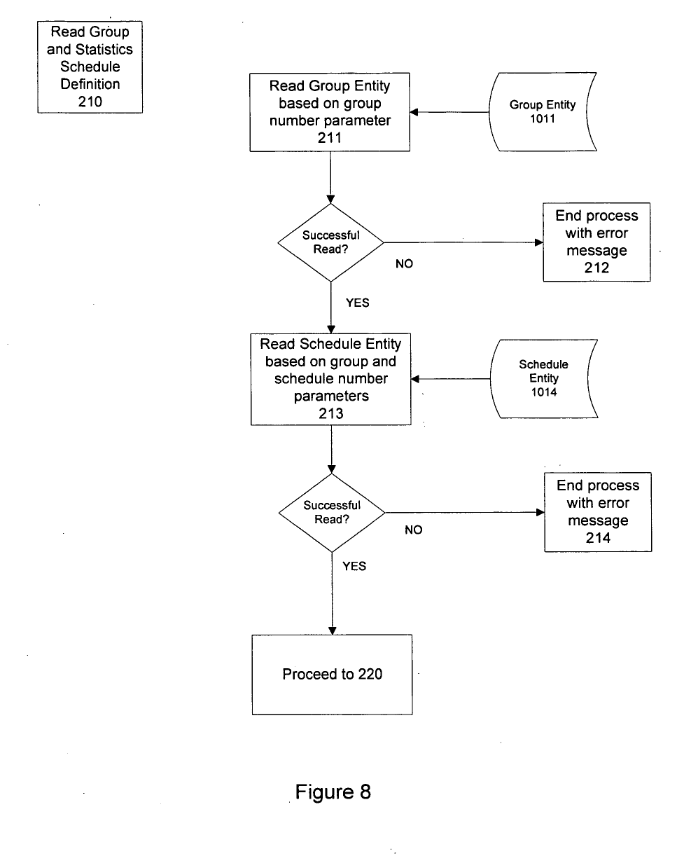

FIG. 8 is a detailed flow chart for Step 210, Read Group and Statistics Schedule Definition, of FIG. 6. At Step 211, the Read Group Entity process reads the Group Entity based on a group number parameter. If there is a successful read at step 211, the Read Schedule Entity process reads the Schedule Entity at step 213 based on a group number parameter, a schedule number parameter, and the type of schedule being generated. An End process, step 212, executes if the group number parameter value was not found in the Group Entity. Proceeding without a defined group is not possible and creates an error.

If there is a successful read at step 213, then step 220 is executed. An End process executes at step 214 if the group number parameter, schedule number parameter, and schedule type values were not found in the Schedule Entity. Proceeding without a defined schedule is not possible and creates an error.

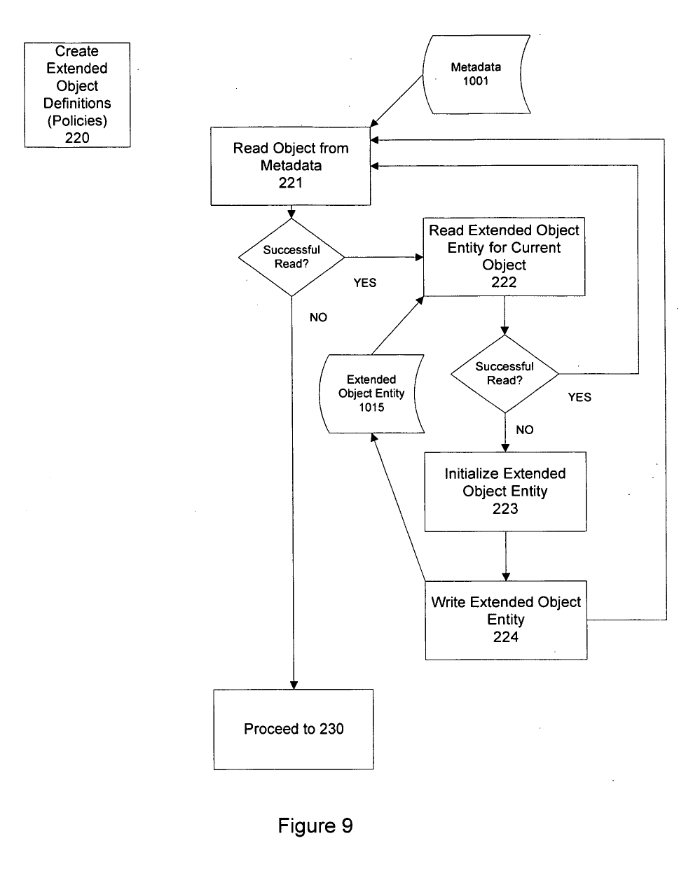

FIG. 9 is a detailed flow chart for Step 220, Create Extended Object Definitions or Policies for any new objects, of FIG. 6. At Step 221 the Read Object from Metadata process reads objects from the system catalog. If there is a successful read at step 221, step 222 reads the Extended Object Entity for Current Object. This process reads the Extended Object Entity for the current object that was previously read in step 221. If the object is successfully read at step 222, then step 221 is executed.

Step 223 initializes the Extended Object Entity, assuming an existing Extended Object definition for the current object was not found at step 222. A default statistics schedule number, a default reorg schedule number, and a default copy schedule number are taken from the Group Entity of step 210, and Step 224 writes a new Extended Object definition to the Extended Object Entity data store 1015. This data will be used later in the statistics, reorg, and copy scheduling processes.

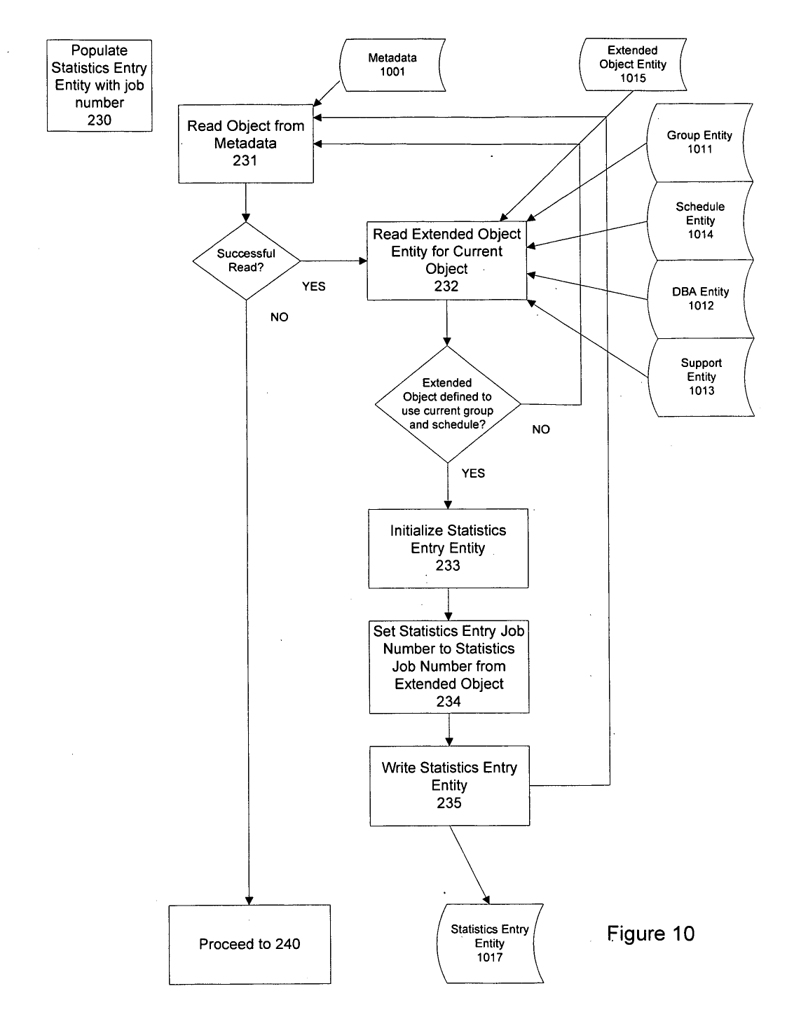

FIG. 10 is a detailed flow chart for Step 230, Populate Statistics Entry Entity with job number, of FIG. 6. At Step 231, the Read Objects from Metadata process reads objects from the system catalog, Metadata data store 1001.

If there is a successful read at step 231, step 232 reads the Extended Object Entity for Current Object that was previously read in step 231. Step 232 obtains data from data stores 1015, 1011, 1014, 1012, and 1013. If the current Extended Object is defined for the current group and schedule, then step 233 initializes the Statistics Entry Entity.

At step 234, the Set Statistics Entry Job Number process sets the Statistics Entry job number to the statistics job number from the Extended Object. This value can be 0 (zero) or a nonzero value. If the value is zero, the dynamic balancing method will be used to place the object in the appropriate job. If the value is nonzero, the object will be placed in that job. At Step 235, the Write Statistics Entry Entity process physically writes a new Statistics Entry definition to the Statistics Entry Entity data store 1017. This data will be used later in the statistics scheduling processes. In this example, step 230 uses a zero or non-zero indicator to indicate whether an object is to be forced to a specific job. In general, other types of schemes may be used to make this indication.

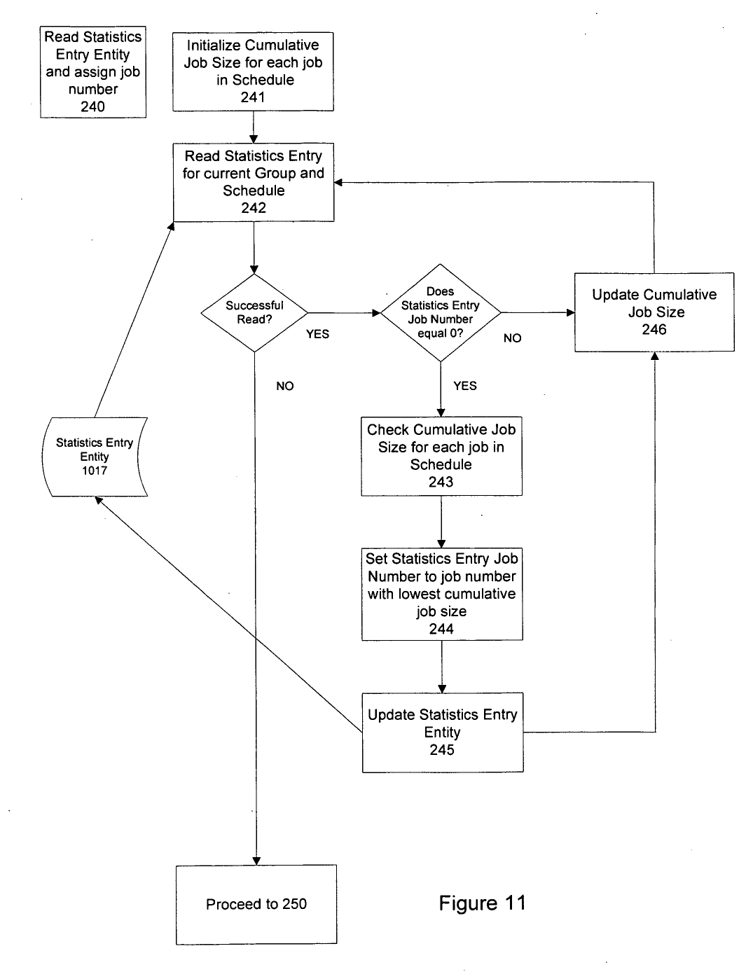

FIG. 11 is a detailed flow chart for Step 240, Read Statistics Entry Entity and assign job number, of FIG. 6. At Step 241, the Initialize Cumulative Job Size for each job in Schedule process sets an internal counter for each job in the current statistics schedule. For example, if the statistics schedule is defined to use 25 jobs, 25 internal counters will all be initialized to 0 (zero). These counters will contain the cumulative job size of each of the 25 jobs. At Step 242, the Read Statistics Entry Entity process reads Statistics Entry definitions that are defined to use the current group and schedule.

If there is a successful read at step 242, then step 246 is executed for Statistics Entry Entity 1017 objects with non-zero job numbers, and step 243 is executed for Statistics Entry Entity objects 1017 objects with zero job numbers. At Step 246, the Update Cumulative Job Size process updates the counter, for the job identified in step 243. The size of the updated Statistics Entry is added to the counter of the job.

At Step 243, the Check Cumulative Job Size for each job process checks the counter(s) that were initialized in step 241, to find the job number that has the lowest cumulative job size. At Step 244, the Set Statistics Entry Job Number process sets the Statistics Entry job number to the job number found in step 243. At this point, the object defined in the Statistics Entry definition will be placed in a specific job in the current statistics schedule. At Step 245, the Update Statistics Entry Entity process physically updates the Statistics Entry Entity data store 1017 with the specific job number. In this example, step 240 uses a least cumulative job size heuristic to assign and balance job scheduling. Other types of scheduling heuristics may also be used, such as 1) evenly dividing the number of objects across concurrent jobs regardless of object type, or 2) placing tablespaces in one procedure or process and indexspaces in another, or 3) by placing indexes first and then tablespaces, or 4) by placing tablespaces first and then index spaces.

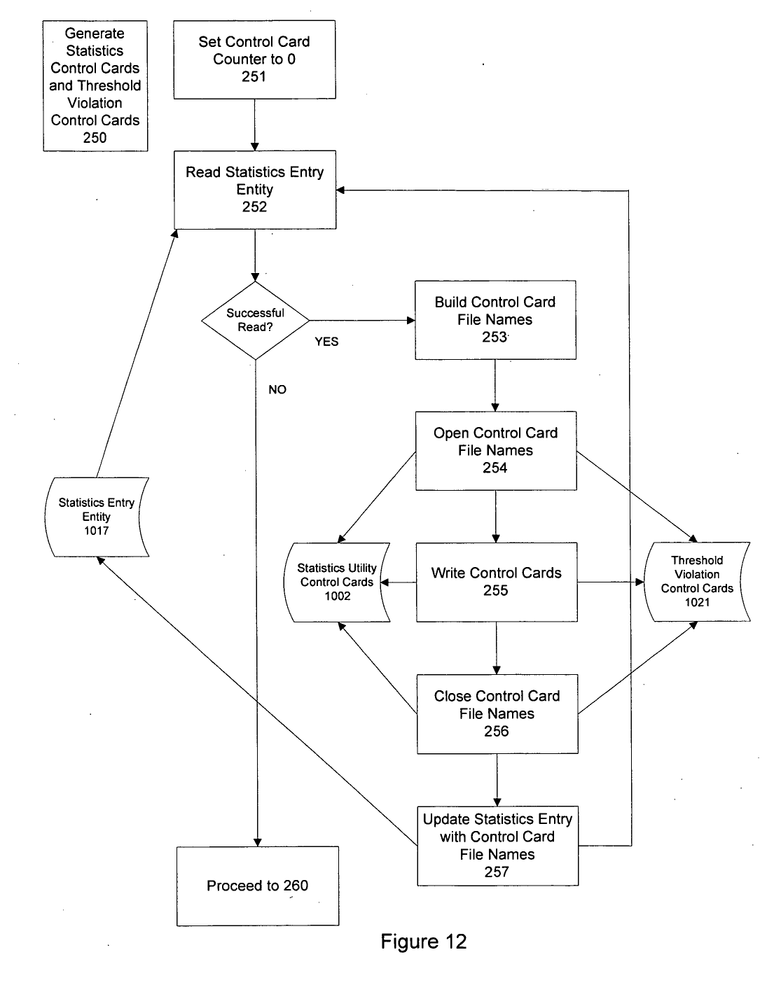

FIG. 12 is a detailed flow chart for Step 250, Generate Statistics Control Cards and Threshold Violation Control Card, of FIG. 6. At Step 251, the Set Control Card counter to 0 process sets an internal counter to aid in generating control card file names. At Step 252, the Read Statistics Entry Entity process reads Statistics Entry definitions that are defined to used the current group and schedule.

If there is a successful read at step 252, then the Step 253, Build Control Card File Names process generates control card file names for the statistics and threshold violation control cards. The counter defined in step 251 is increased by 1 and the control card file names are generated. At Step 254, the Open Control Card File Names process opens the control card file names which are generated at step 253; and the Threshold Violation Control Cards data store 1021 and Statistics Control Cards data store 1002 are populated. The Threshold Violation Control Cards are used as input to a routine that detects and optionally reports on threshold violations. At Step 255, the Write Control Cards process writes the control cards for the statistics utility and threshold violation detection process. The control cards are formatted, based on the vendor specification defined in the current statistics schedule. At Step 256, the Close Control Card File Names process closes the control card file names that were opened in step 254. At Step 257, the Update Statistics Entry with Control Cards File Names process physically updates the Statistics Entry 1017 definition with the control card file names generated in step 253.

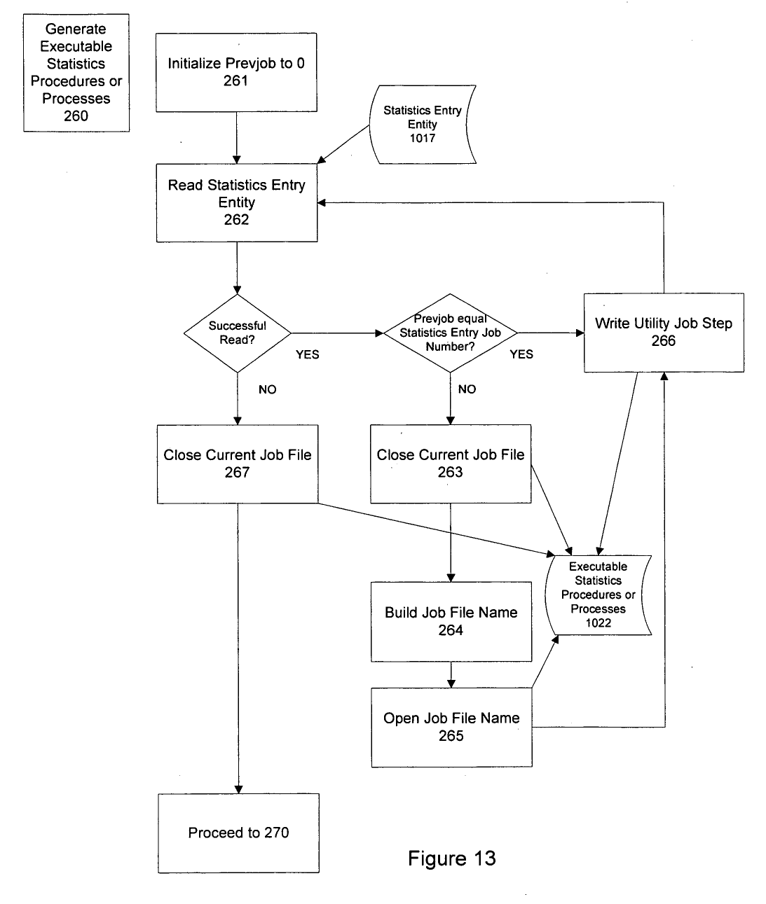

FIG. 13 is a detailed flow chart for Step 260, Generate Executable Procedures or Processes, of FIG. 6. At Step 261, the Initialize Prevjob to 0 process sets an internal counter to aid in determining when job numbers change. At Step 262, the Read Statistics Entry Entity process reads Statistics Entry definitions that are defined to used the current group and schedule.

If there is a not successful read at step 262, then the step 267 Close Current Job File process closes the job file name that was opened in step 265 and step 270 is executed.

If there is a successful read at step 262, then step 266 is executed if the prevjob is the same as the statistics entry job number. At Step 266, the Write Utility Job Step process writes the statistics utility step and threshold violation detection process step, for the current Statistics Entry definition. The steps are formatted, based on the vendor specification in the current statistics schedule definition. These job procedures or processes are written to a repository for later processing.

At Step 263, the Close Current Job File process closes the job file name that was opened in step 265. The first time the process is executed, there is no previously opened file name, so the close process is bypassed. At Step 264, the Build Job File Name process generates a job file name from the procedure prefix and suffix characteristics in the statistics schedule definition. It also uses the Statistics Entry job number to create the actual name of the file. At Step 265, the Open Job File Name process opens the job file name that was generated in step 264 and updates the Executable Statistics Procedures or Processes data store 1022.

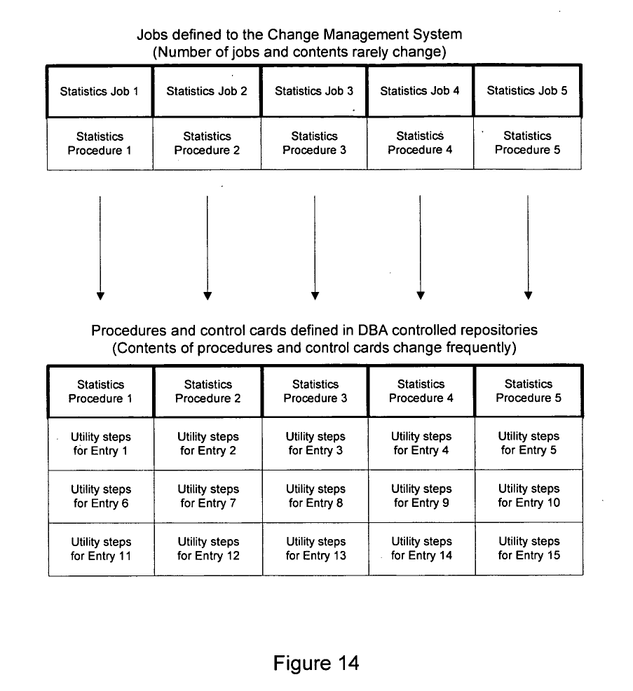

FIG. 14 illustrates the dynamically balanced statistics schedule generated by Step 260, Generate Executable Procedures or Processes, and processed by Step 270, Execute Statistics and Threshold Violation Jobs, of FIG. 6. Each job in the statistics schedule is designed to execute concurrently with other jobs in the schedule.

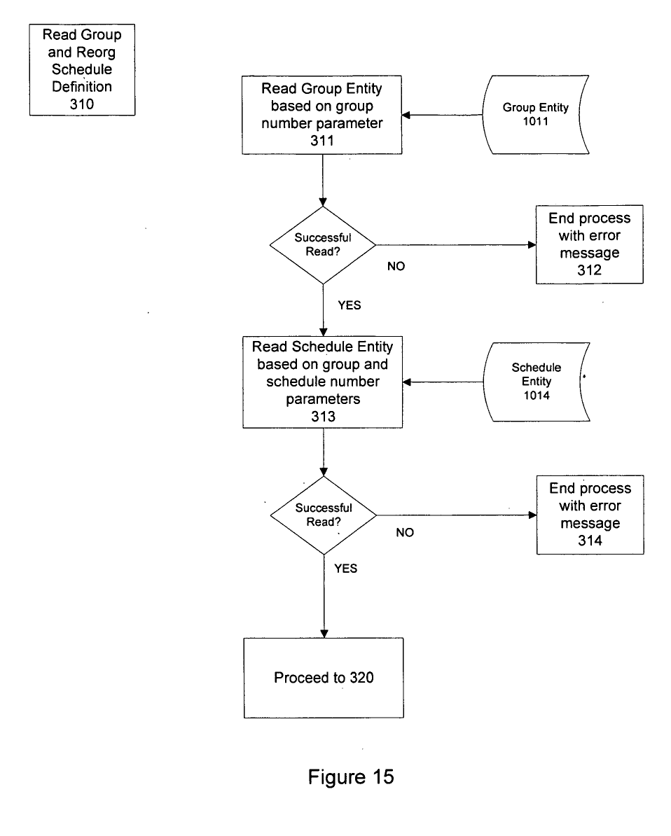

FIG. 15 is a detailed flow chart for Step 310, Read Group and Reorg Schedule Definition, of FIG. 7. At Step 311, the Read Group Entity process reads the Group Entity based on a group number parameter. The Step 312 End process executes if the group number parameter value was not found in the Group Entity. Proceeding without a defined group is not possible and creates an error.

If the read at step 311 is successful, then at Step 313, the Read Schedule Entity process reads the Schedule Entity based on a group number parameter, a schedule number parameter, and the type of schedule being generated. The Step 314 End process executes if the group number parameter, schedule number parameter, and schedule type values were not found in the Schedule Entity. Proceeding without a defined schedule is not possible and creates an error.

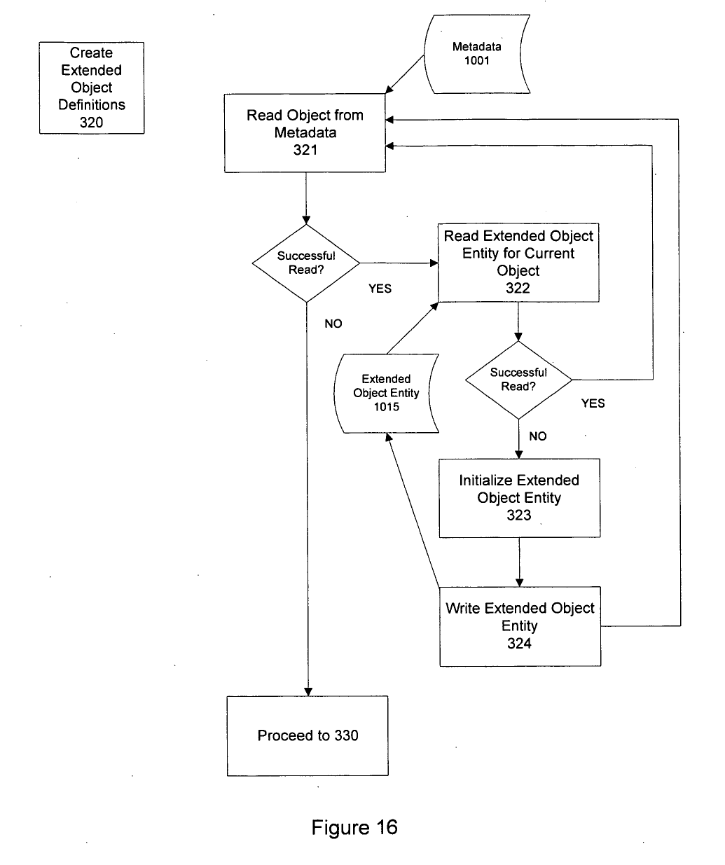

FIG. 16 is a detailed flow chart for Step 320, Create Extended Object Definitions or Policies, of FIG. 7. At Step 321, the Read Object from Metadata process reads objects from the system catalog 1001. If the read at step 321 is successful, then at At Step 322, the Read Extended Object Entity for Current Object process reads the Extended Object Entity for the current object that was previously read in step 321. If an existing Extended Object definition for the current object was not found at step 322, then the process at Step 323 initializes the Extended Object Entity. A default statistics schedule number, a default reorg schedule number, and a default copy schedule number are taken from the Group Entity in step 310.

At Step 324, the Write Extended Object Entity process physically writes a new Extended Object definition to the Extended Object Entity data store 1015. This data will be used later in the statistics, reorg, and copy scheduling processes.

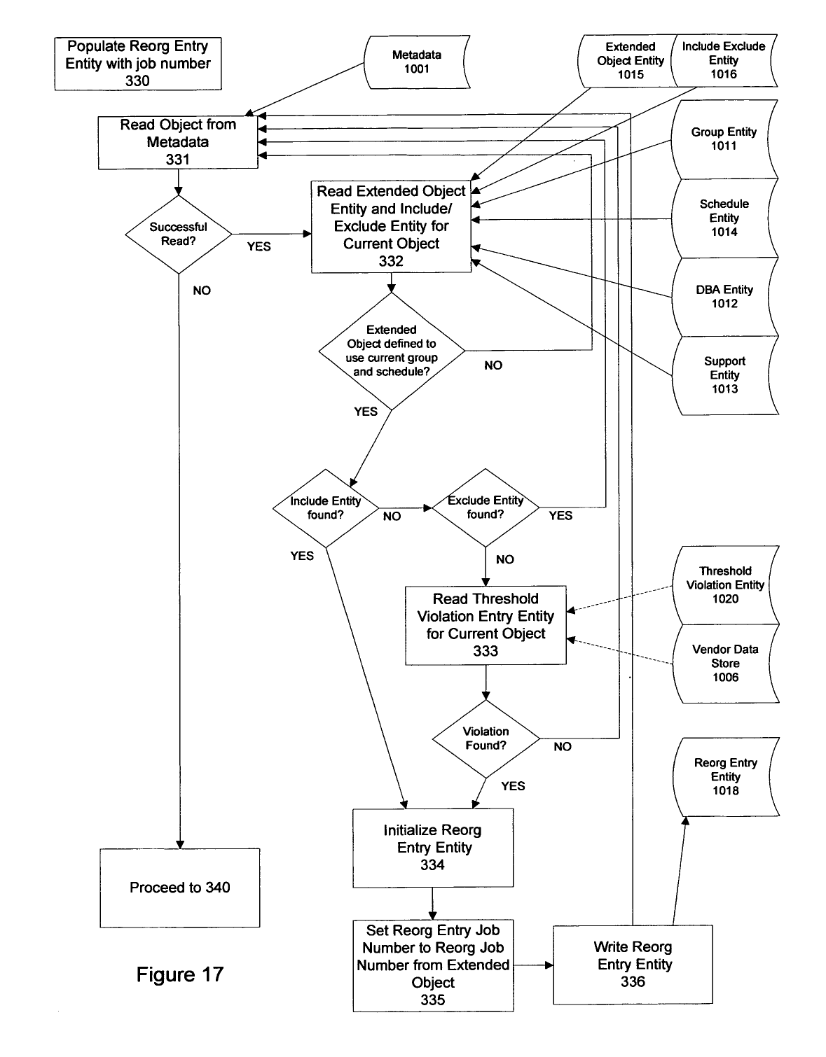

FIG. 17 is a detailed flow chart for Step 330, Populate Reorg Entry Entity, of FIG. 7. At Step 331, the Read Objects from Metadata process reads objects from the system catalog 1001. If the read is successful, the Step 332, Read Extended Object Entity for Current Object process reads the Extended Object Entity for the current object that was previously read in step 331. At Step 333, the Read Threshold Violation Entry Entity for Current Object process reads the Threshold Violation Entity or a Vendor Data Store (if the vendor software being used has the capability to store threshold violation data). If there is a threshold violation, the Step 334, Initialize Reorg Entry Entity process initializes the Reorg Entry Entity. At Step 335, the Set Reorg Entry Job Number process sets the Reorg Entry job number to the reorg job number from the Extended Object. This value can be 0 (zero) or a nonzero value. If the value is zero, the dynamic balancing method will be used to place the object in the appropriate job. If the value is nonzero, the object will be placed in that job. At Step 336, the Write Reorg Entry Entity process physically writes a new Reorg Entry definition to the Reorg Entry Entity data store 1018. This data will be used later in the reorg scheduling processes. In this example, step 330 uses a zero or non-zero indicator to indicate whether an object is to be forced to a specific job. In general, other types of schemes may be used to make this indication.

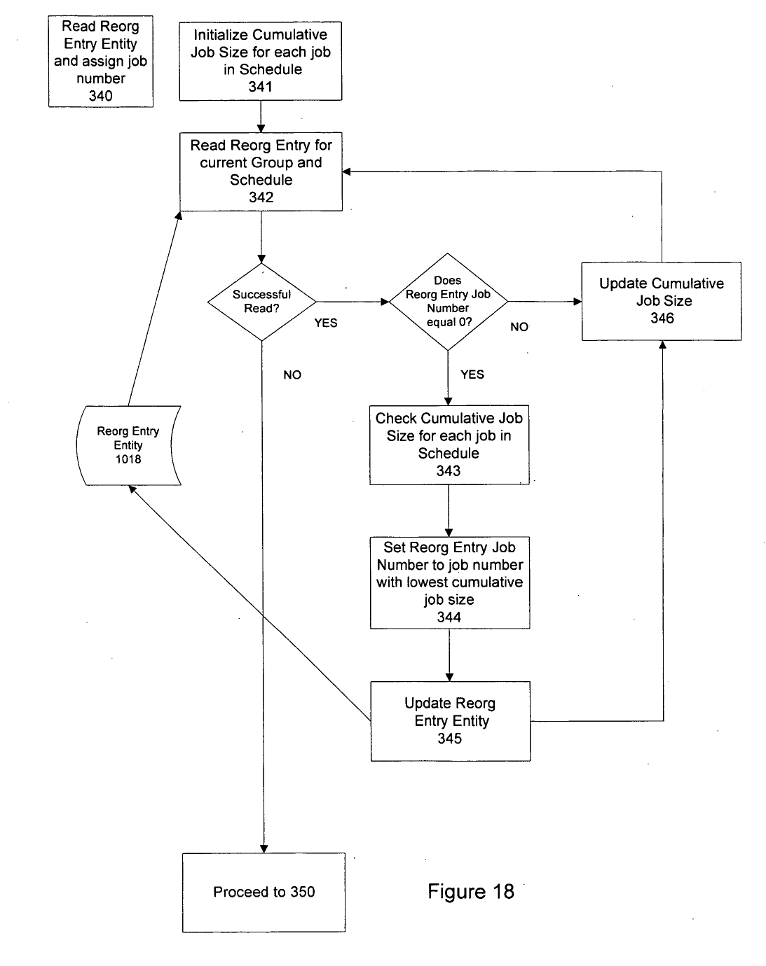

FIG. 18 is a detailed flow chart for Step 340, Read Reorg Entry Entity and assign job number, of FIG. 7. At Step 341, the Initialize Cumulative Job Size for each job in Schedule process sets an internal counter for each job in the current reorg schedule. For example, if the reorg schedule is defined to use 12 jobs, 12 internal counters will all be initialized to 0 (zero). These counters will contain the cumulative job size of each of the 12 jobs. At Step 342, the Read Reorg Entry Entity process reads Reorg Entry definitions that are defined to use the current group and schedule. If the Reorg entry job number is not zero, then at Step 346, the Update Cumulative Job Size process updates the counter, for the job. The size of the updated Reorg Entry is added to the counter of the job.

If the Reorg entry job number is zero, at Step 343, the Check Cumulative Job Size for each job process checks the counter(s) that were initialized in step 341, to find the job number that has the lowest cumulative job size. At Step 344, the Set Reorg Entry Job Number process sets the Reorg Entry job number to the job number found in step 343. At this point, the object defined in the Reorg Entry definition will be placed in a specific job in the current reorg schedule. At Step 345, the Update Reorg Entry Entity process physically updates the Reorg Entry Entity data store 1018 with the specific job number. In this example, step 340 uses a least cumulative job size heuristic to assign and balance job scheduling. Other types of scheduling heuristics may also be used, such as 1) evenly dividing the number of objects across concurrent jobs regardless of object type, or 2) placing tablespaces in one procedure or process and indexspaces in another, or 3) by placing indexes first and then tablespaces, or 4) by placing tablespaces first and then index spaces.

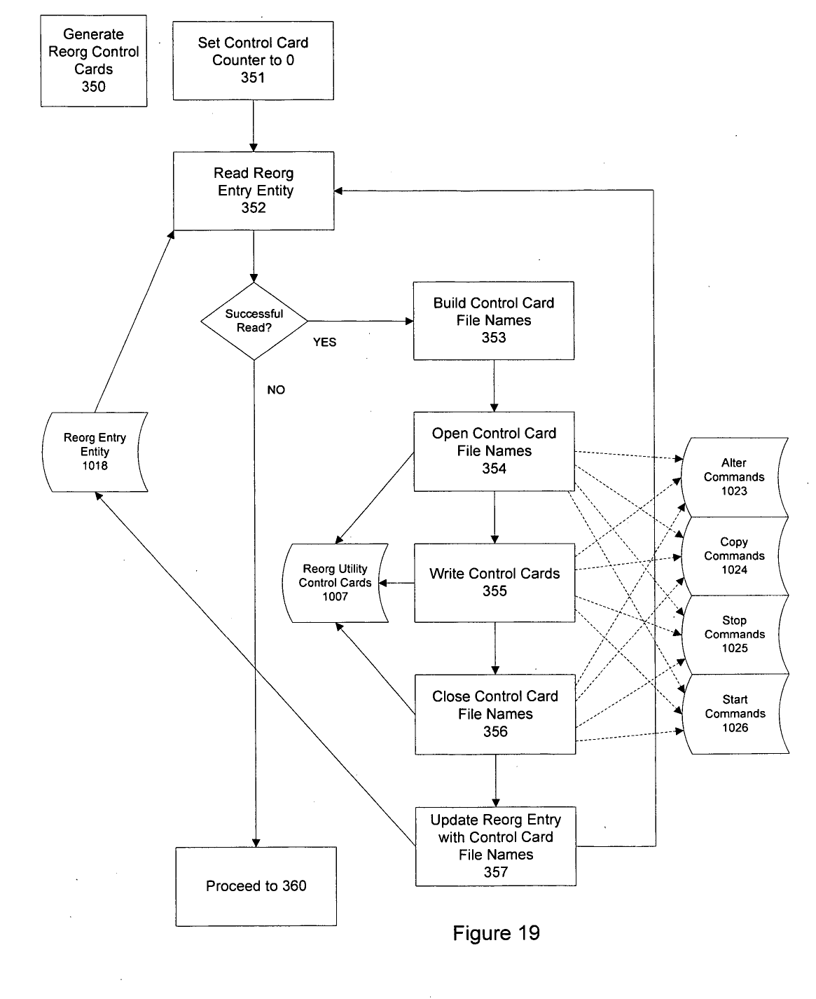

FIG. 19 is a detailed flow chart for Step 350, Generate Reorg Control Cards, of FIG. 7. At Step 351, the Set Control Card counter to 0 process sets an internal counter to aid in generating control card file names. At Step 352, the Read Reorg Entry Entity process reads Reorg Entry definitions that are defined to use the current group and schedule.

At Step 353, the Build Control Card File Names process generates control card file names for the reorg, and optional alter, copy, stop, and start command control cards. The counter defined in step 351 is increased by 1 and the control card file names are generated. The alter, copy, stop, and start commands are generated only for certain platforms. At Step 354, the Open Control Card File Names process opens the control card file names generated in step 353. At Step 355, the Write Control Cards process writes the control cards for the reorg utility. The control cards are formatted, based on the vendor specification defined in the current reorg schedule. Alter, copy, stop, and start commands may also be generated, each in a specific control card file name. At Step 356, the Close Control Card File Names process closes the control card file names that were opened in step 354. At Step 357, the Update Reorg Entry with Control Cards File Names process physically updates the Reorg Entry Entity data store 1018 with the control card file names generated in step 353.

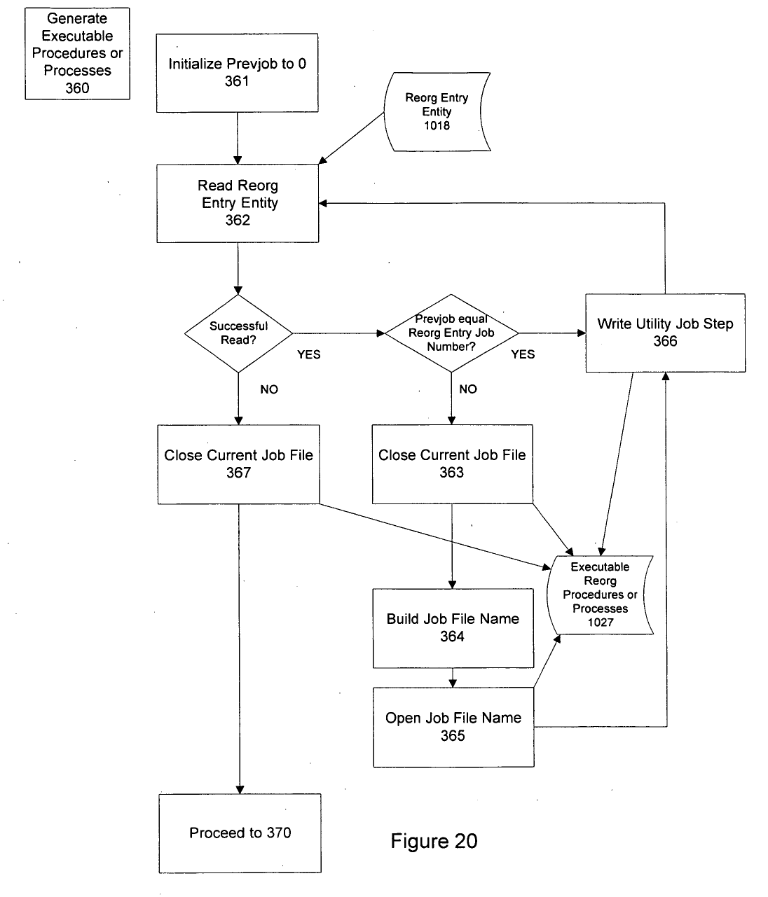

FIG. 20 is a detailed flow chart for Step 360, Generate Executable Procedures or Processes, of FIG. 7. At Step 361, the Initialize Prevjob to 0 process sets an internal counter to aid in determining when job numbers change. At Step 362, the Read Reorg Entry Entity process reads Reorg Entry definitions that are defined to use the current group and schedule.

At Step 363, the Close Current Job File process closes the job file name that was opened in step 365. The first time the process is executed, there is no previously opened file name, so the close process is bypassed. At Step 364, the Build Job File Name process generates a job file name from the procedure prefix and suffix characteristics in the reorg schedule definition. It also uses the Reorg Entry job number to create the actual name of the file. At Step 365, the Open Job File Name process opens the job file name that was generated in step 364. At Step 366, the Write Utility Job Step process writes the reorg utility step, and additional steps for any alter, copy, stop, and start commands that were generated, for the current Reorg Entry definition. The steps are formatted, based on the vendor specification in the current reorg schedule definition. These job procedures or processes are written to the Executable Reorg Procedures or Processes data store 1027 for later processing. When all job files have been read, the Close Current Job File process at Step 367, closes the job file name that was opened in step 365.

FIG. 21 illustrates the dynamically balanced reorganization schedule generated by Step 360, Generate Executable Procedures or Processes, and processed by Step 370, Execute Reorg Jobs, of FIG. 7. Each job in the reorganization schedule is designed to execute concurrently with other jobs in the schedule.

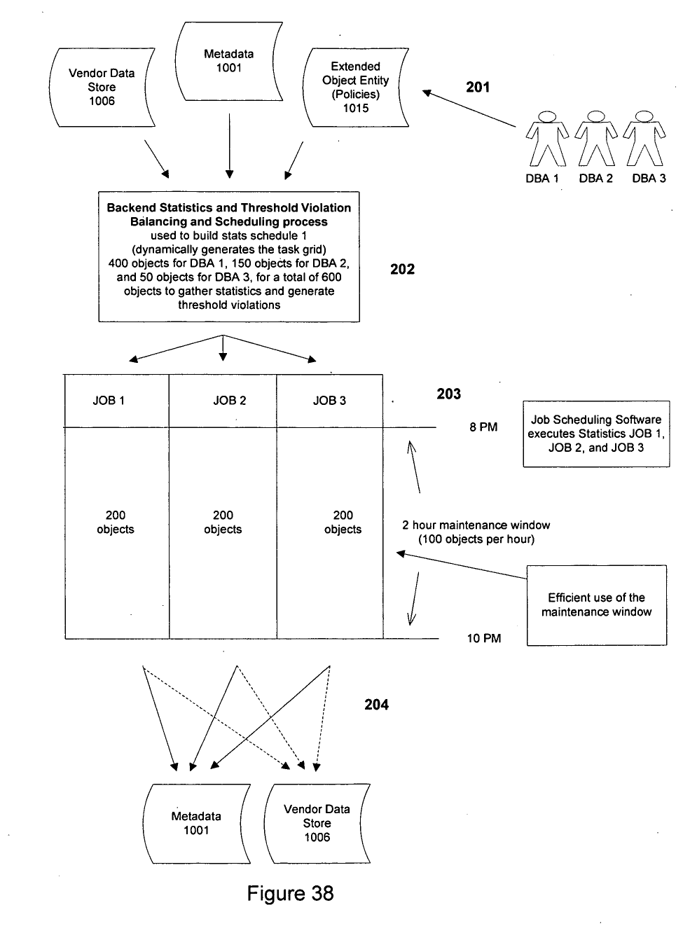

FIG. 38 is a high-level overview of the current invention FIG. 4 step 200, Generate Statistics and Threshold Violations. It shows an approach that that the current invention uses to generate statistics and threshold violations. In this example: DBA1 has 400 objects, DBA2 has 150 objects, and DBA3 has 50 objects. At 201, each DBA would use the online interface to add his objects or policies to statistics schedule 1. This action is required only once, unless the DBA wants to put the object or policy in another statistics schedule. At 202, the backend process detects all objects assigned to statistics schedule 1. This list of objects is made up of objects supported by many DBAs. From this list of objects, the backend process dynamically builds an internal grid of statistics and threshold violation maintenance tasks. The grid is constructed via the balancing technique, based on one or more dimensions, and is the core technology of the current invention. The grid is then materialized as series of executable jobs, based on the number of jobs for statistics schedule 1. The dynamic and balanced nature of the grid inherently makes efficient use of the maintenance window. At 203, typically a job-scheduling product would execute the previously built statistics and threshold violation jobs. At 204, the executed jobs would gather statistics and generate threshold violations for each of the objects. Statistics are written to the Metadata 1001 and threshold violations are written to the Vendor Data Store 1006. The main benefits with this approach are 1) all objects are dynamically balanced across jobs for the schedule, 2) there is little or no manual effort involved in configuring the policies, and 3) the maintenance window overall is used efficiently.

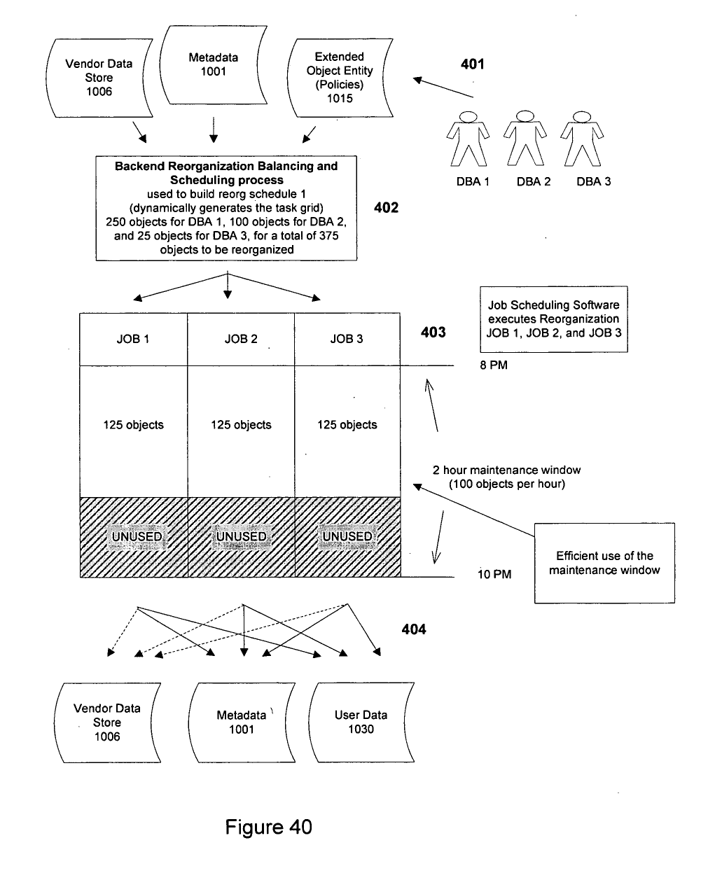

FIG. 40 is a high-level overview of the current invention FIG. 4 step 300, Perform Reorgs. It shows an approach that that the current invention uses to generate reorganization jobs. In this example: DBA1 has 400 objects with 250 objects needing reorganization, DBA2 has 150 objects with 100 objects needing reorganization, and DBA3 has 50 objects with 25 objects needing reorganization. At 401, each DBA would use the online interface to add his objects or policies to reorganization schedule 1. This action is required only once, unless the DBA wants to put the object or policy in another reorganization schedule. At 402, the backend process detects all objects assigned to reorganization schedule 1. The backend process then looks for current threshold violations for each of the objects. The resulting list of database objects are then objects assigned to reorganization schedule 1 and have current threshold violations. This is the coupling or seamless integration depicted in FIG. 4 steps 200 and 300. This list of objects is made up of objects supported by many DBAs. From this list of objects, the backend process dynamically builds an internal grid of reorganization maintenance tasks. The grid is constructed via the balancing technique, based on one or more dimensions, and is the core technology of the current invention. The grid is then materialized as series of executable jobs, based on the number of jobs for reorganization schedule 1. The dynamic and balanced nature of the grid inherently makes efficient use of the maintenance window. At 403, typically a job-scheduling product would execute the previously built reorganization jobs. At 404, the executed jobs would gather reorganize each of the objects. The Metadata 1001 is updated to reflect the reorganizations, as well as the Vendor Data Store 1006, if used. The User Data 1030 is reorganized. The main benefits with this approach are 1) all objects are dynamically balanced across jobs for the schedule, 2) there is little or no manual effort involved in configuring the policies, and 3) the maintenance window overall is used efficiently.

### DETAILED DESCRITPION OF EMBODIMENT—BALANCING AND SCHEDULING DATABASE COPY AND BACKUP TASKS AND RECOVERY TASKS

In this embodiment, copy or backup tasks are scheduled and balanced in a manner similar to that of the statistics and reorganization task schedules. The current invention also dynamically generates copy or backup schedules and corresponding recovery tasks.

The recovery tasks are not scheduled in any way, but are generated, so that in the event that a recovery is required, the necessary jobs and commands are pre-built. In this embodiment, the schedule balancing method used for the copy or backup schedules, is identical to that used by the statistics and reorganization schedule generation processes.

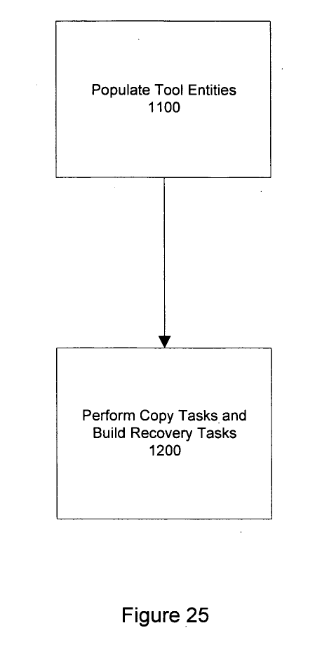

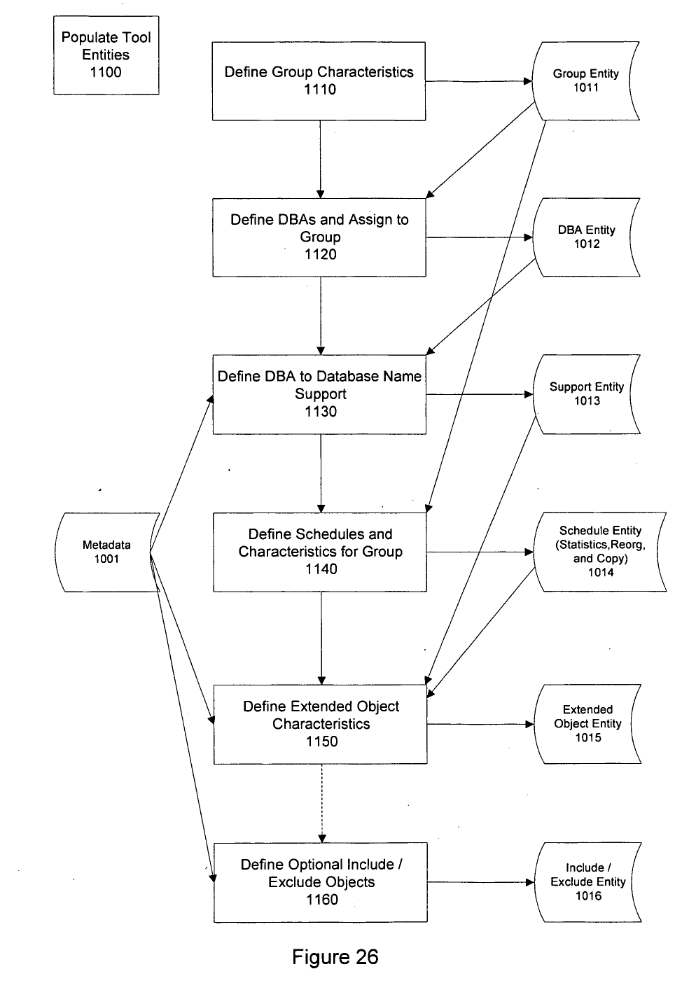

FIG. 25 is a high level flowchart for the current invention that includes populating tool entities, generating and performing copy tasks and building recovery tasks. It should be noted that FIG. 5 (statistics and reorganization tool entity population) is identical to FIG. 26 (copy and recovery tool entity population). At Step 1100, Populate Tool Entities, an online process allows the database administrator to define various entities required by the tool, and to define characteristics of the database objects themselves.

At step 1200, the Perform Copy Tasks and Build Recovery Tasks core process determines how database objects will be copied or backed up, and how those objects will be recovered. This process is executed based on a group and schedule number.

FIG. 26 is a detailed flow chart for Step 1100, Populate Tool Entities, of FIG. 25. Step 1110, Define Group Characteristics, allows the DBA to define characteristics of the Group entity 1011. The Group Entity data store 1011 is the highest level entity required by the current invention. The entity represents a technical group, or a team of people, responsible for managing database objects. Examples of a group would be a production support DBA group, a systems administration DBA group, or a test DBA group. Characteristics of the Group entity data store comprise a group number, a description, default statistics schedule number, default reorg schedule number, default copy schedule number, a product load library name or path name, a user load library name or path name, an optional attach name and high-level qualifier, a last update userid, and last update timestamp. Other characteristics may be included. These characteristics are platform independent.

Step 1120, Define DBAs and Assign to Group, allows the DBA to define DBA userids to a group. This process directly ties a DBA to a group. The DBA Entity data store 1012 represents an individual database administrator (DBA). Characteristics of the DBA entity comprise a userid, a group number (used to tie the DBA entity to the Group entity), and contact information that may include phone number, pager number, email address, among others. Other characteristics may also be included. These characteristics are platform independent. For distributed platforms like UNIX and Windows: the userid value would most likely be the instance owner id.

Step 1130, Define DBA to Database Name Support, allows the DBA to define the relationship between DBA userids and database names. Indirectly, this ties a database name to a group, via the DBA entity. The Support Entity data store 1013 represents a relationship between a DBA entity and a database name. Once created, there is an implicit relationship between a database name and a group, via the DBA entity. Hence, a database is supported by only one group. Characteristics of the Support entity comprise a database name, a userid (from the DBA entity), a last update userid, and a last update timestamp. Other characteristics may also be included. These characteristics are platform independent. For host platforms like OS/390 or z/OS: the database name value could be any user database. For distributed platforms like UNIX or Windows: the database name value would be any database name in the database management instance.

Step 1130 reads the Metadata data store 1001 which comprises object definitions, including table definitions, column definitions, view definitions, authorization definitions, and others. This repository is usually referred to as the system catalog, and is the main repository for database management systems such as DB2, Oracle, and others.

Step 1140, Define Schedules and Characteristics for Group, allows the DBA to define schedules and characteristics of those schedules, for the group. The Schedule Entity data store 1014 represents a utility schedule for a group. In this embodiment, this entity has three types—Statistics, Reorg, and Copy. Other schedule types may be added as needed. In this embodiment, a group can have up to 99 schedules for each schedule type. Characteristics of the Schedule entity comprise a schedule number, a schedule type, a group number, a description, the number of concurrent jobs, a procedure library or path name, a control card library or path name, a share level for the schedule, a procedure or process name for the utility, the utility vendor, a procedure or process prefix, a procedure or process suffix, threshold specifications, various utility-specific parameters, a last update userid, and a last update timestamp. Other characteristics may also be included. These characteristics are platform independent. A key characteristic of each schedule is the number of concurrent jobs allowed. This provides the basis for the balancing function. Other example characteristics are repository names for procedures and control cards. These repository names can be libraries or directories.

Step 1150, Define Extended Object Characteristics, allows the DBA to define extended characteristics of database objects. Examples include job numbers for statistics, reorg, and copy processes. If these job numbers are left at the default value of zero, the object is placed in a specific job based on the dynamic balancing process. If nonzero values are supplied, the object is placed in that job. The object definition allows for job numbers for each schedule type.

The Extended Object Entity data store 1015 (Policy) represents an extended definition of an object. An extended definition is defined as characteristics required by or implemented by the tool that do not exist in the database management system metadata 1001 system catalog. Characteristics of the Extended Object entity comprise an object name, a statistics schedule number, a reorg schedule number, up to five copy schedule numbers, a forced reorg schedule job number, up to five forced copy schedule job numbers, a share level specification, a part level specification, an active/inactive specification, an non-partitioned index specification, an allocation cushion specification, a last update userid, and a last update timestamp. Other characteristics may also be included. These characteristics are platform independent. Typical characteristics are defined in FIG. 36. Other characteristics may be added as appropriate. Each database object has a unique maintenance policy.

Step 1160, Define Optional Include/Exclude Objects, is optional and allows the DBA to force an object into a given reorg schedule. The main purpose for this process is to include the reorg of an object to occur, even though there were no threshold violations for the object. An example of why this process might be used is to physically move the object from one disk array or DASD device to another. The Include/Exclude Entity data store 1016 is an optional entity which is provided so that an object can be forced, either included into or excluded from, a reorg schedule. The entity represents a forced object. Characteristics of the Include/Exclude entity comprise an object name, an include or exclude specification, an optional allocation specification, a beginning and ending date range denoting the time period the specification is to be honored, a last update userid, and a last update timestamp. Other characteristics may also be included. These characteristics are platform independent.

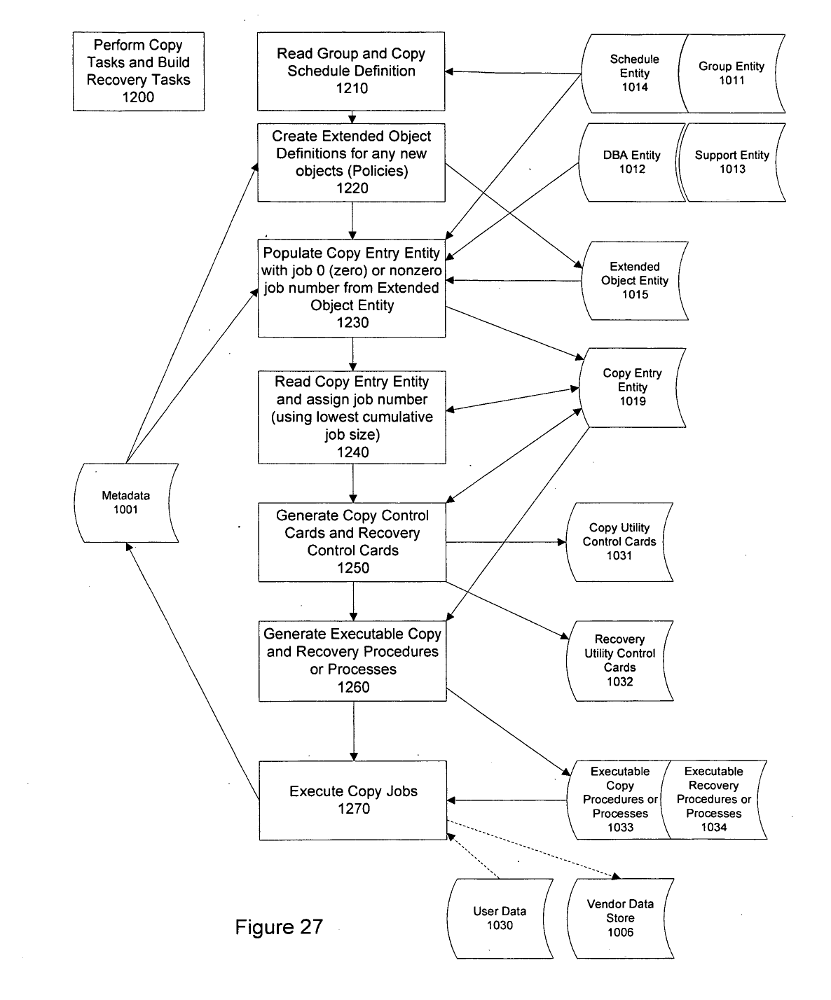

FIG. 27 is a detailed flow chart for Step 1200, Perform Copy Tasks and Build Recovery Tasks, of FIG. 25. Step 1210, Read Group and Copy Schedule Definition, is executed by the batch, or backend, task. Characteristics of the group and copy schedule are used to determine processing requirements. Step 1210 uses information from the Schedule Entity data store 1014 and the Group Entity data store 1011.

Step 1220, Create Extended Object Definitions or Policies for any new objects, is executed by the batch, or backend task. This step automatically defines Extended Object Entity Definitions or Policies 1015, with default characteristics, for any new objects that were not previously defined in the tool.

Step 1230, Populate Copy Entry Entity with job number, reads all objects tied to the group and that are defined to use the copy schedule in progress. Objects are read from the Metadata based on group/schedule/DBA/support/size and priority. Size is determined by, but not limited to, any of the following: 1) number of active pages; 2) current physical allocation; or 3) row length of the objects multiplied by the number of rows in the table(s). Other dimensions could also be used to denote size of an object. Priority is optionally assigned by the user based on the objects' importance to the enterprise. The process defines instances of a new entity, or Copy Entry for each object. A job value of 0 (zero) or the copy job number from the Object Entity are used. A job value of 0 (zero) indicates the use of the dynamic balancing method. A nonzero value dictates a forced placement into a specific job. This step reads information from Group Entity data store 1011, Schedule Entity data store 1014, DBA Entity data store 1012, and Support Entity data store 1013.

In this embodiment, the Copy Entry Entity data store 1019 is populated internally. The entity represents an object entry in a copy schedule. Characteristics of the Copy Entry entity comprise an object name, a job number, the physical size of the object, control card file name(s), a last update userid, and a last update timestamp, among others. Other characteristics may also be included.

Step 1240, Read Copy Entry Entity and assign job number, comprises the core balancing method of the current embodiment. As each row of the Copy Entry data store 1019 for this group and schedule are read, a job number is assigned if the initial job number is 0 (zero). To determine in which job the object is placed, a cumulative job size, for each job, is maintained. As each row of the Copy Entry is read, the cumulative job size, for each job, is reviewed. The job number in the Copy Entry is modified to reflect the job number with the lowest cumulative job size. If, however, the Copy Entry job number is nonzero, the object is placed in that specific job. In either case, the cumulative job size is updated to reflect the addition of the object into the job.

Step 1250, Generate Copy Control Cards and Recovery Control Cards, reads the updated Copy Entry 1019 objects, for the group and schedule, and generates the necessary copy and recovery control cards, based on what vendor utility is being used. These control cards are written to a repository for later processing. The Copy Control Cards data store 1031 and Recovery Control Cards data store 1032 are populated automatically by the current invention. The copy control cards are used as input to any copy utility, and direct the execution of the utility. The recovery control cards are used in the recovery effort.

At Step 1260, Generate Executable Copy and Recovery Procedures or Processes, reads the updated Copy Entry 1019 objects, for the group and schedule, and generates the necessary copy and recovery job procedures or processes, based on what vendor utility is being used. These job procedures or processes are written to a repository for later processing. The Executable Copy Procedures or Processes data store 1033 and Executable Recovery Procedures or Processes 1034 are populated automatically by the current invention. The procedures or processes make up the executable portion of the copy and recovery maintenance effort. Logically, the procedures or processes appear as a grid of individual copy and recovery utility tasks. Each procedure or process is executed by, or invoked from, a calling job or shell. Together, the procedures inherently maximize resource efficiency in the maintenance window.

At Step 1270, the Execute Copy Jobs process generates a copy or backup of the database object and writes them to the metadata repository 1001 and/or vendor repository. The User Data 1030 data store, is used as the source for the copy tasks. The Vendor Data Store 1006 exists if an organization has vendor software that augments the copy generation process. Not all vendors provide these entities or processes. The current invention fills in gaps created by not having currently available vendor software. Furthermore, the resulting balanced schedule of copy tasks, maximize resources in the maintenance window. In the prior art, the vendor data store entries are possibly generated, but no vendor currently supports the dynamic generation of copy jobs in a controlled manner. Nor does any vendor attempt to create a balanced set of tasks, focusing on maximizing maintenance window resources.

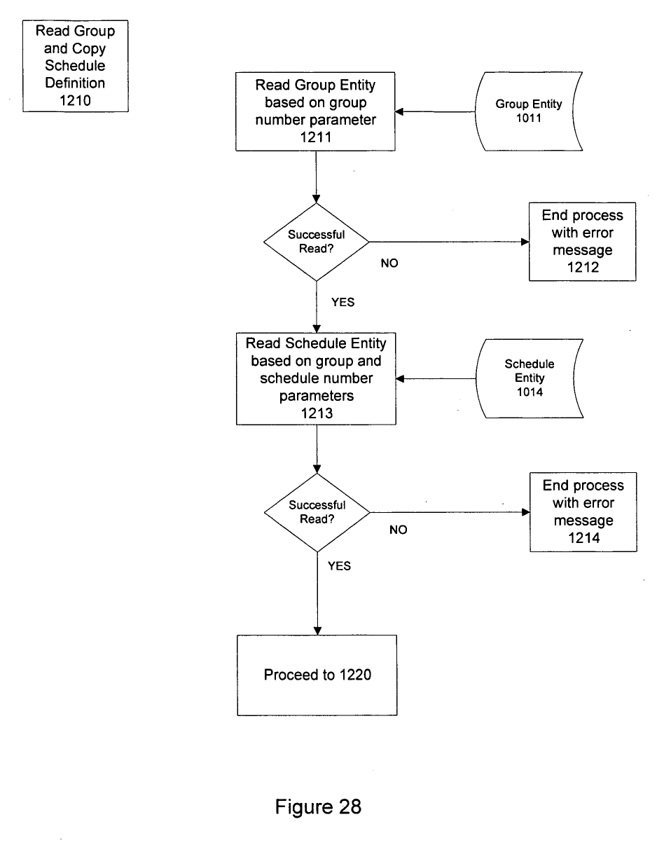

FIG. 28 is a detailed flow chart for Step 1210, Read Group and Copy Schedule Definition, of FIG. 27. At Step 1211, the Read Group Entity process reads the Group Entity based on a group number parameter. If there is a successful read at step 1211, the Read Schedule Entity process reads the Schedule Entity at step 1213 based on a group number parameter, a schedule number parameter, and the type of schedule being generated. An End process, step 1212, executes if the group number parameter value was not found in the Group Entity. Proceeding without a defined group is not possible and creates an error.

If there is a successful read at step 1213, then step 1220 is executed. An End process executes at step 1214 if the group number parameter, schedule number parameter, and schedule type values were not found in the Schedule Entity. Proceeding without a defined schedule is not possible and creates an error.

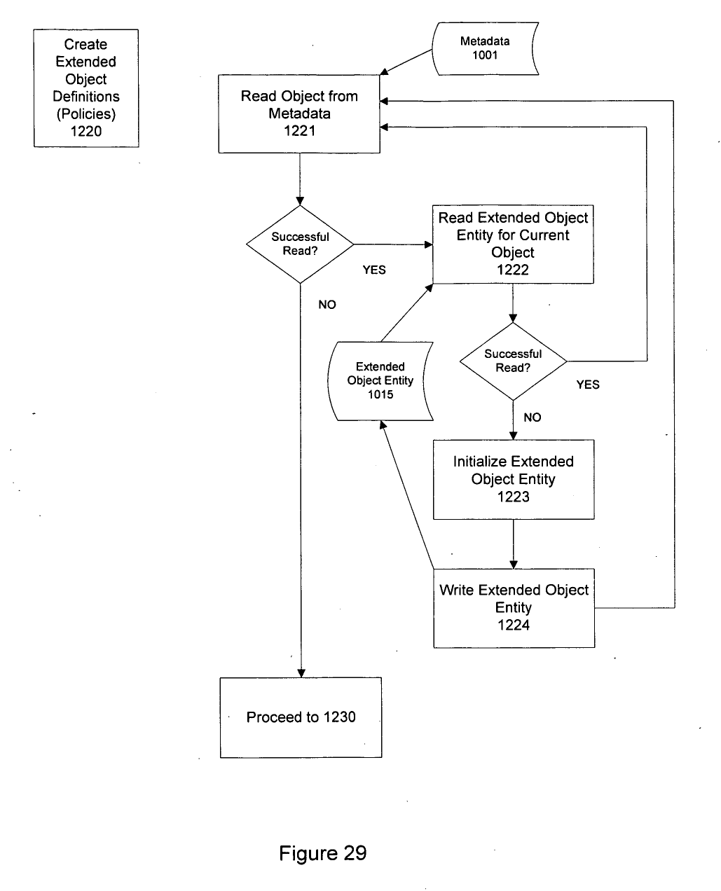

FIG. 29 is a detailed flow chart for Step 1220, Create Extended Object Definitions or Policies for any new objects, of FIG. 27. At Step 1221 the Read Object from Metadata process reads objects from the system catalog. If there is a successful read at step 1221, step 1222 reads the Extended Object Entity for Current Object. This process reads the Extended Object Entity for the current object that was previously read in step 1221. If the object is successfully read at step 1222, then step 1221 is executed.

Step 1223 initializes the Extended Object Entity, assuming an existing Extended Object definition for the current object was not found at step 1222. A default statistics schedule number, a default reorg schedule number, and a default copy schedule number are taken from the Group Entity of step 1210, and Step 1224 writes a new Extended Object definition to the Extended Object Entity data store 1015. This data will be used later in the statistics, reorg, and copy scheduling processes.

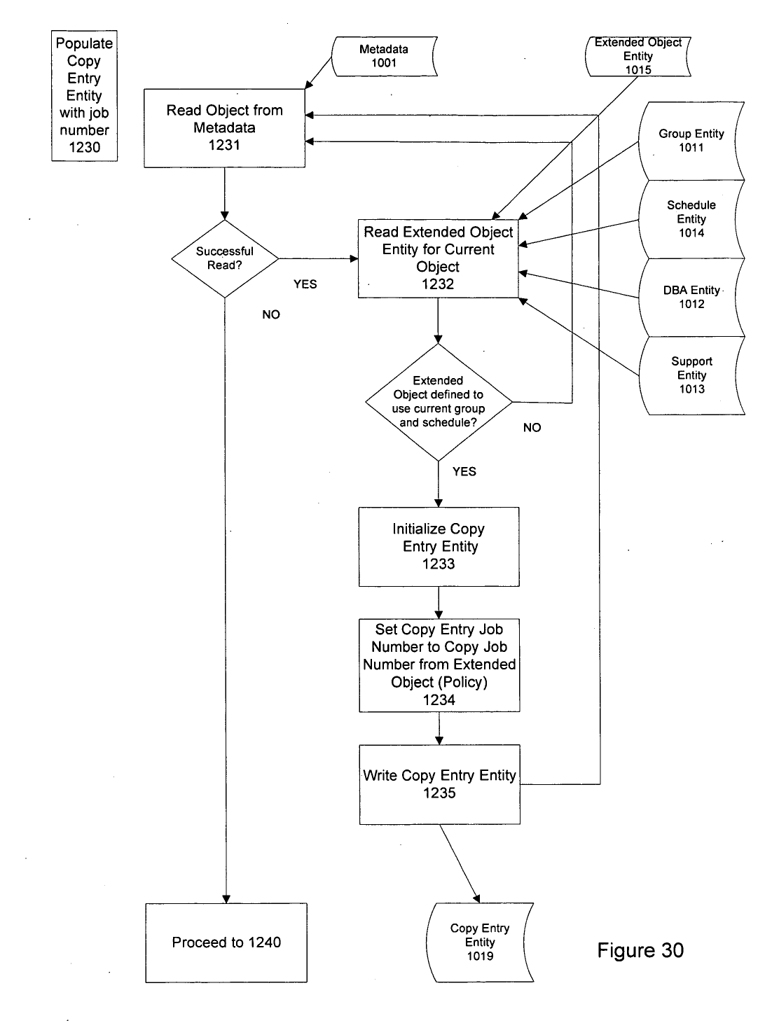

FIG. 30 is a detailed flow chart for Step 1230, Populate Copy Entry Entity with job number, of FIG. 27. At Step 1231, the Read Objects from Metadata process reads objects from the system catalog, Metadata data store 1001.

If there is a successful read at step 1231, step 1232 reads the Extended Object Entity for Current Object that was previously read in step 1231. Step 1232 obtains data from data stores 1015, 1011, 1014, 1012, and 1013. If the current Extended Object is defined for the current group and schedule, then step 1233 initializes the Copy Entry Entity.

At step 1234, the Set Copy Entry Job Number process sets the Copy Entry job number to the copy job number from the Extended Object. This value can be 0 (zero) or a nonzero value. If the value is zero, the dynamic balancing method will be used to place the object in the appropriate job. If the value is nonzero, the object will be placed in that job. At Step 1235, the Write Copy Entry Entity process physically writes a new Copy Entry definition to the Copy Entry Entity data store 1019. This data will be used later in the copy scheduling processes. In this example, step 1230 uses a zero or non-zero indicator to indicate whether an object is to be forced to a specific job. In general, other types of schemes may be used to make this indication.

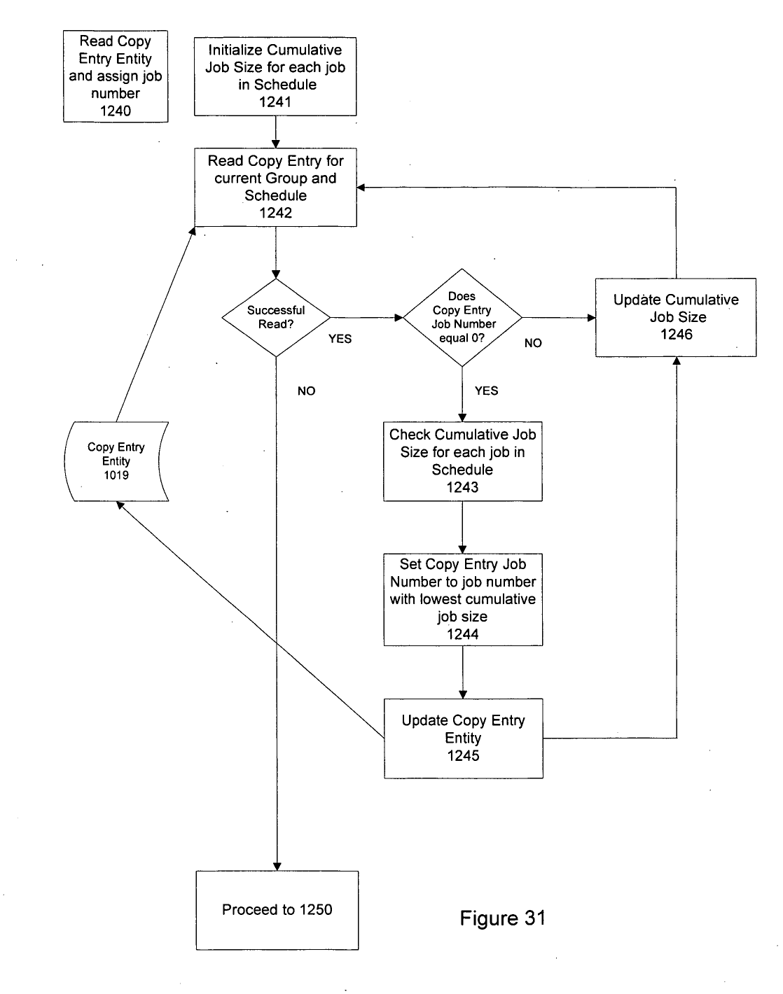

FIG. 31 is a detailed flow chart for Step 1240, Read Copy Entry Entity and assign job number, of FIG. 27. At Step 1241, the Initialize Cumulative Job Size for each job in Schedule process sets an internal counter for each job in the current copy schedule. For example, if the copy schedule is defined to use 25 jobs, 25 internal counters will all be initialized to 0 (zero). These counters will contain the cumulative job size of each of the 25 jobs. At Step 1242, the Read Copy Entry Entity process reads Copy Entry definitions that are defined to use the current group and schedule.

If there is a successful read at step 1242, then step 1246 is executed for Copy Entry Entity 1019 objects with non-zero job numbers, and step 1243 is executed for Copy Entry Entity objects 1019 objects with zero job numbers. At Step 1246, the Update Cumulative Job Size process updates the counter, for the job identified in step 1243. The size of the updated Copy Entry is added to the counter of the job.

At Step 1243, the Check Cumulative Job Size for each job process checks the counter(s) that were initialized in step 1241, to find the job number that has the lowest cumulative job size. At Step 1244, the Set Copy Entry Job Number process sets the Copy Entry job number to the job number found in step 1243. At this point, the object defined in the Copy Entry definition will be placed in a specific job in the current copy schedule. At Step 1245, the Update Copy Entry Entity process physically updates the Copy Entry Entity data store 1019 with the specific job number. In this example, step 1240 uses a least cumulative job size heuristic to assign and balance job scheduling. Other types of scheduling heuristics may also be used, such as 1) evenly dividing the number of objects across concurrent jobs regardless of object type, or 2) placing tablespaces in one procedure or process and indexspaces in another, or 3) by placing indexes first and then tablespaces, or 4) by placing tablespaces first and then indexspaces.

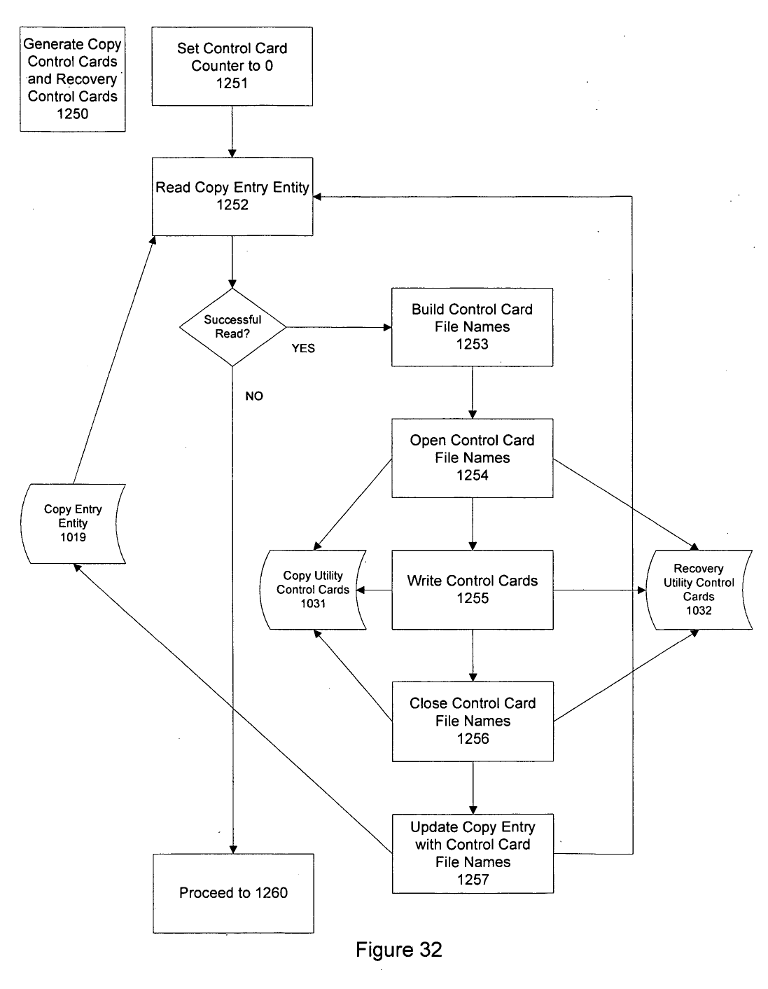

FIG. 32 is a detailed flow chart for Step 1250, Generate Copy Control Cards and Recovery Control Cards, of FIG. 27. At Step 1251, the Set Control Card counter to 0 process sets an internal counter to aid in generating control card file names. At Step 1252, the Read Copy Entry Entity process reads Copy Entry definitions that are defined to used the current group and schedule.

If there is a successful read at step 1252, then the Step 1253, Build Control Card File Names process generates control card file names for the copy and recovery control cards. The counter defined in step 1251 is increased by 1 and the control card file names are generated. At Step 1254, the Open Control Card File Names process opens the control card file names which are generated at step 1253; and the Copy Utility Control Cards data store 1031 and Recovery Utility Control Cards data store 1032 are populated. At Step 1255, the Write Control Cards process writes the control cards for the copy utility and recovery utility processes. The control cards are formatted, based on the vendor specification defined in the current copy schedule. At Step 1256, the Close Control Card File Names process closes the control card file names that were opened in step 1254. At Step 1257, the Update Copy Entry with Control Cards File Names process physically updates the Copy Entry 1019 definition with the control card file names generated in step 1253.

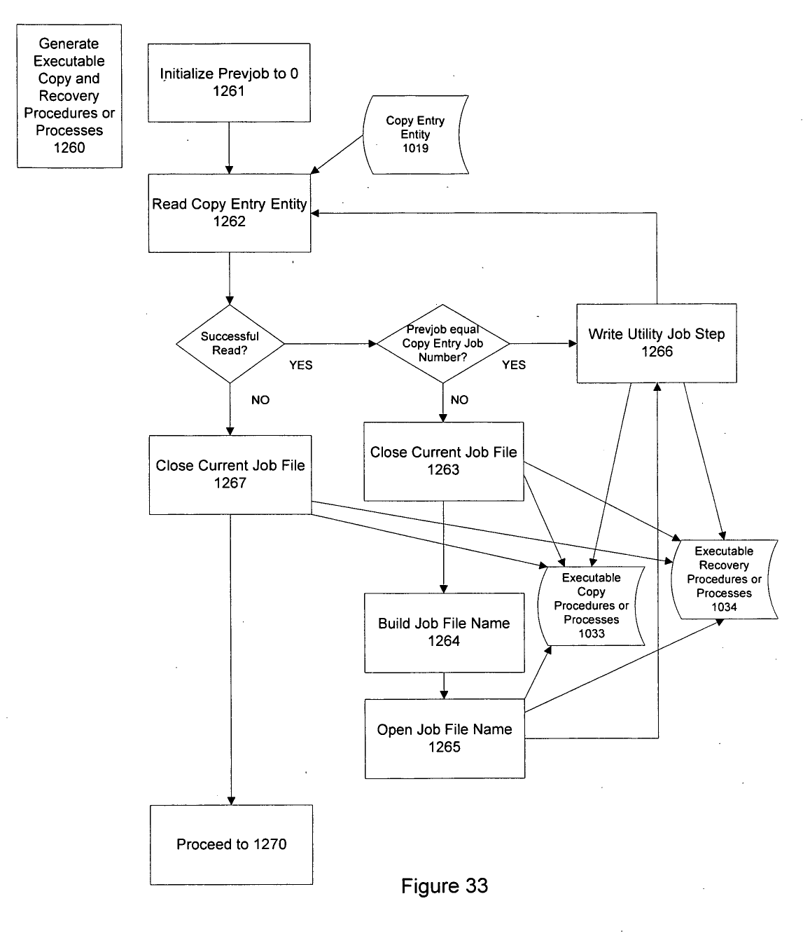

FIG. 33 is a detailed flow chart for Step 1260, Generate Executable Copy and Recovery Procedures or Processes, of FIG. 27. At Step 1261, the Initialize Prevjob to 0 process sets an internal counter to aid in determining when job numbers change. At Step 1262, the Read Copy Entry Entity process reads Copy Entry definitions that are defined to use the current group and schedule.

If there is a not successful read at step 1262, then the step 1267 Close Current Job File process closes the job file name that was opened in step 1265 and step 1270 is executed.

If there is a successful read at step 1262, then step 1266 is executed if the prevjob is the same as the copy entry job number. At Step 1266, the Write Utility Job Step process writes the copy utility step and recovery utility step, for the current Copy Entry definition. The steps are formatted, based on the vendor specification in the current copy schedule definition. These job procedures or processes are written to a repository for later processing.

At Step 1263, the Close Current Job File process closes the job file name that was opened in step 1265. The first time the process is executed, there is no previously opened file name so the close process is bypassed. At Step 1264, the Build Job File Name process generates a job file name from the procedure prefix and suffix characteristics in the copy schedule definition. It also uses the Copy Entry job number to create the actual name of the file. At Step 1265, the Open Job File Name process opens the job file name that was generated in step 1264 and updates the Executable Copy Procedures or Processes data store 1033 and the Executable Recovery Procedures or Processes data store 1034. At this point, the recovery jobs and recovery control cards have been dynamically generated for the current group and schedule, and are available if recovery is necessary. At step 1270, Execute Copy Jobs, the copy tasks are executed.

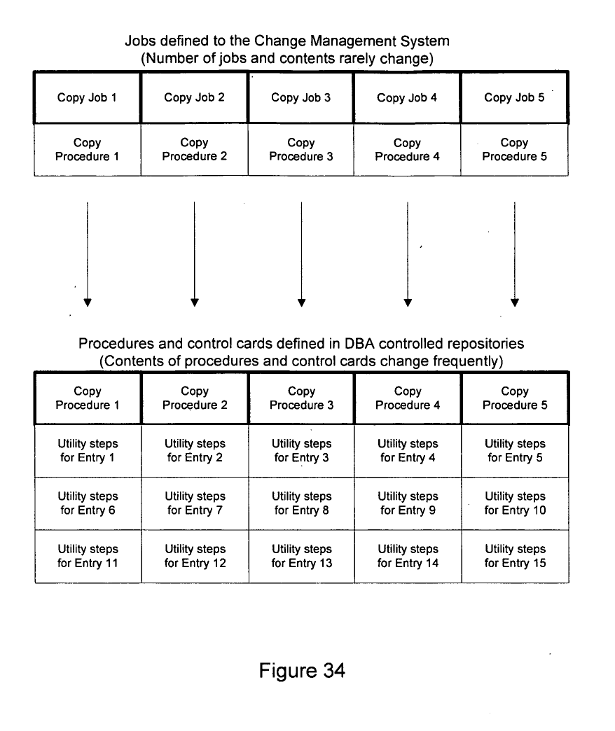

FIG. 34 illustrates the dynamically balanced copy schedule generated by Step 1260, Generate Executable Copy and Recovery Procedures or Processes, and processed by Step 1270, Execute Copy Jobs. Each job in the copy schedule is designed to execute concurrently with other jobs in the schedule.

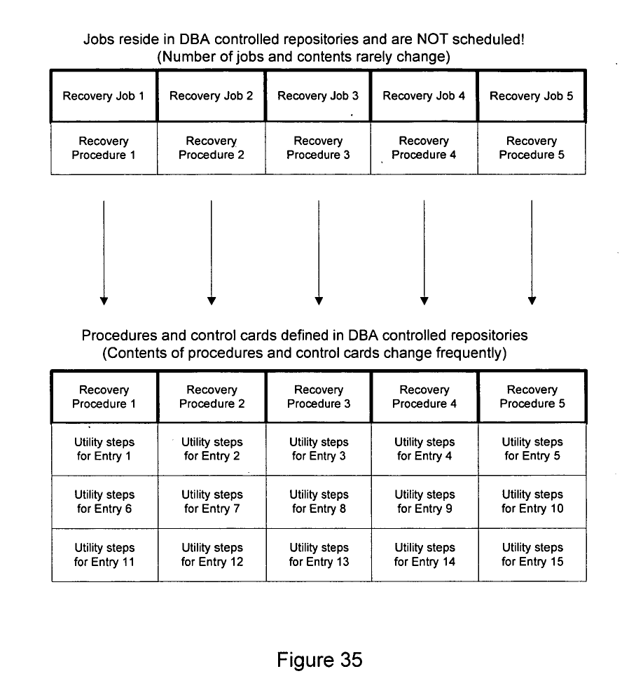

FIG. 35 illustrates the dynamically balanced recovery schedule generated by Step 1260, Generate Executable Copy and Recovery Procedures or Processes. Each job in the recovery schedule is designed to execute concurrently with other jobs in the schedule. These procedures and control cards are automatically generated, but not executed until required. An extremely important artifact of the current invention is the automatic generation of disaster recovery jobs and control cards.

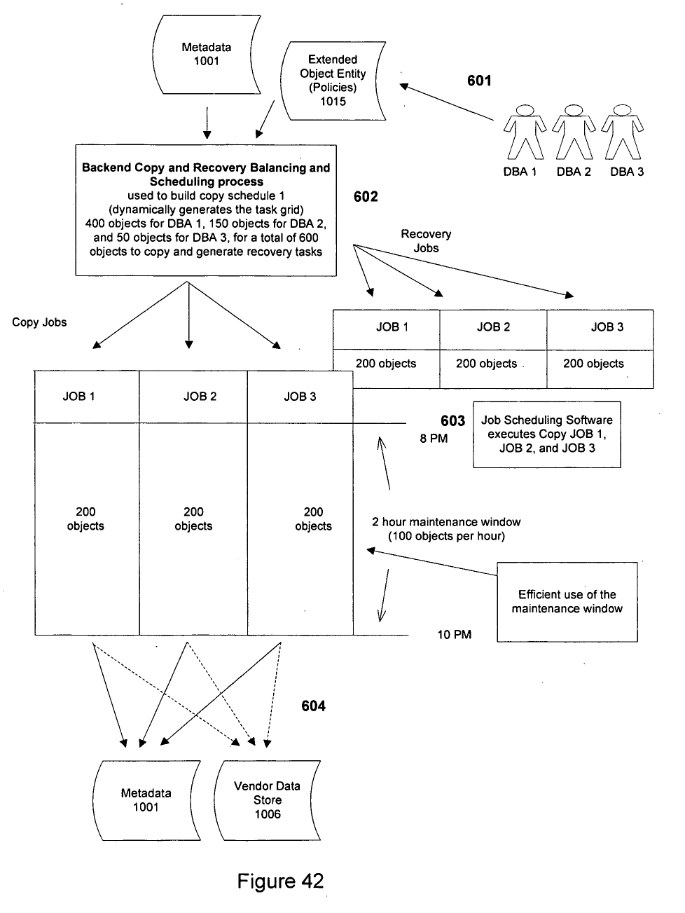

FIG. 42 is a high-level overview of the current invention FIG. 25 step 1200, Perform Copy Tasks and Build Recovery Tasks. It shows the approach that that the current invention uses to generate copy or backup jobs and recovery jobs. In this example: DBA1 has 400 objects, DBA2 has 150 objects, and DBA3 has 50 objects. At 601, each DBA would use the online interface to add his objects or policies to copy schedule 1. This action is required only once, unless the DBA wants to put the object or policy in another copy schedule. At 602, the backend process detects all objects assigned to copy schedule 1. This list of objects is made up of objects supported by many DBAs. From this list of objects, the backend process dynamically builds an internal grid of copy and recovery maintenance tasks. The grid is constructed via the balancing technique, based on one or more dimensions, and is the core technology of the current invention. The grid is then materialized as series of executable jobs, based on the number of jobs for copy schedule 1. The grid is also materialized as a series of executable recovery jobs, based on the number of jobs for copy schedule 1. These recovery jobs are automatically created but are only used if a recovery is required. These recovery jobs are also a mirror image of the copy or backup jobs. Having these recovery jobs created prior to actually needed them is a major aspect of the current invention. At 603, typically a job-scheduling product would execute the previously built copy jobs. At 604, the executed jobs would copy each of the objects. The recovery jobs are immediately available if recovery is required. The Metadata 1001 is updated to reflect the copy or backup. The User Data 1030 is copied. The main benefits with this approach are 1) all objects are dynamically balanced across jobs for the schedule, 2) there is little or no manual effort involved in configuring the policies, and 3) the maintenance window overall is used efficiently.

1. A method for balancing and scheduling database maintenance tasks for a plurality of database objects in a database, such that the tasks are assigned across a plurality of jobs within a task schedule, the method comprising
defining characteristics for each of the plurality of database objects, the characteristics including at least one indicator of whether to force the object into a particular maintenance job;
establishing jobs and a maintenance task grid for the schedule, such that the maintenance task grid stores information about the objects that are assigned to jobs within the schedule;
assigning each database object of the plurality of database objects to a job by
forcing the object to a particular job, if the indicator designates the particular job,
using a core balancing technique to assign the object to a job, if the indicator does not designate a particular job, and
updating the grid to reflect the assignment of the object to a job; and
scheduling and executing the tasks related to the objects assigned to each job.

2. The method of claim 1 wherein
the database maintenance tasks comprise gathering statistics and threshold violations for the plurality of database objects; and
the maintenance task grid is a statistics grid.

3. The method of claim 2 further comprising
generating and storing threshold violations for the plurality of database objects;
using the threshold violations to identify a set of objects to be reorganized; and
establishing reorganization jobs and a reorganization task grid for a reorganization schedule, such that the reorganization task grid stores information about the set of objects to be reorganized;
assigning each of the set of objects to be reorganized to a reorganization job by
forcing the object to a particular reorganization job, if the indicator designates the particular reorganization job,
using a core balancing technique to assign the object to a reorganization job, if the indicator does not designate a particular reorganization job, and
updating the reorganization grid to reflect the assignment of the object to a reorganization job; and
scheduling and executing the reorganization jobs.

4. The method of claim 1 wherein
the database maintenance tasks comprise reorganizing the plurality of database objects; and
the maintenance task grid is a reorganization grid.

5. The method of claim 1 wherein
the database maintenance tasks comprise copying the plurality of database objects; and
the maintenance task grid is a copy grid.

6. The method of claim 5 wherein the database maintenance tasks comprise generating restore tasks for the plurality of database objects.

7. The method of claim 5 further comprising
generating restore tasks for the plurality of database objects; using the copy tasks to identify a set of objects to be restored; and establishing restore jobs from the copy task grid for a restore schedule, such that the task grid stores information about the set of objects to be restored; assigning each of the set of objects to be restored to a restore job by
forcing the object to a particular restore job, if the indicator designates the particular restore job,
using the core balancing technique to assign the object to a restore job, if the indicator does not designate a particular restore job, and updating the grid to reflect the assignment of the object to a restore job.

8. The method of claim 1 wherein defining characteristics for each of the plurality of database objects further comprises
providing an online interface to assign the characteristics to the database objects.

9. The method of claim 1 wherein the characteristics further include
a statistics schedule number;
a statistics job number;
a reorganization schedule number;
a reorganization job number;
a copy schedule number;
a copy job number;
a reorganization share level;
a copy share level;
a part level;
a non-partitioned index specification;
an active specification;
a priority specification;
a boundary specification; and
a padding specification.

10. The method of claim 1 wherein the maintenance task grid further comprises
a column for each job, such that the column comprises a plurality of cells, and such that each cell represents at least one maintenance task related to an object.

11. The method of claim 1 wherein using a core balancing technique to assign the object to a job further comprises
representing each job as a column comprising a plurality of cells, such that each cell represents at least one task related to an object;
assigning the object to a job according to at least one dimension so that the cumulative job size assigned to the job is approximately equal to the cumulative job size assigned to each of the other jobs in the schedule, so that each job is assigned approximately the same amount of work.

12. The method of claim 11 further comprising
assigning an object to the job having the lowest cumulative job size.

13. The method of claim 11 further comprising
selecting a core balancing technique from the group consisting of evenly dividing the size of object tasks across concurrent jobs regardless of object type, placing tablespaces in one job and indexspaces in another job, placing indexes first and then tablespaces, and placing tablespaces first and then indexspaces.

14. The method of claim 11 further comprising
displaying the maintenance task grid; and
permitting evaluation and modification of the schedule or maintenance task grid.

15. The method of claim 11 wherein assigning the object to a job according to at least one dimension further comprises
sequencing the tasks within a job in any order, including randomly.

16. The method of claim 11 wherein the dimension further comprises a size measurement selected from the list consisting of
the number of active pages for an object; the current physical allocation of an object; and row length of the object multiplied by the number of rows in one or more object table.

17. A method for balancing and scheduling database statistics and reorganization maintenance tasks for a database, the database comprising a first plurality of database objects, the method comprising
defining characteristics for each of the first plurality of database objects, the characteristics including a first indicator of whether to force the object into a particular statistics maintenance job, and a second indicator of whether to force the object into a particular reorganization maintenance job;
scheduling statistics tasks for the first plurality of database objects by
establishing statistics jobs and a statistics task grid for a statistics schedule, such that the statistics task grid stores information about the objects that are assigned to statistics jobs within the statistics schedule,
assigning each database object of the first plurality of database objects to a statistics job by
forcing the object to a particular statistics job, if the first indicator designates a particular statistics job,
using a core balancing technique to assign the object to a statistics job, if the first indicator does not designate a particular statistics job, and
updating the statistics job and task grid to reflect the assignment of the object to a statistics job;
executing the statistics tasks for each job and storing threshold violations;
determining a second plurality of database objects to reorganize by
including in the second plurality objects from the first plurality of database objects according to threshold violations,
removing from the second plurality objects, objects which are designated as excluded from reorganization, and
adding to the second plurality objects, objects which are designated as included in the reorganization; and
scheduling reorganization tasks for the second plurality of database objects by
establishing reorganization jobs and a reorganization task grid for the reorganization schedule, such that the reorganization task grid stores information about the objects that are assigned to reorganization jobs within the reorganization schedule;
assigning each database object of the second plurality of database objects to a reorganization job by
forcing the object to a particular reorganization job, if the second indicator designates the particular reorganization job,
using a core balancing technique to assign the object to a reorganization job, if the second indicator does not designate a particular reorganization job, and
updating the reorganization job and task grid to reflect the assignment of the object to a reorganization job.

18. The method of claim 17 wherein the statistics task grid further comprises
a column for each job, such that the column comprises a plurality of cells, and such that each cell represents at least one maintenance task related to an object.

19. The method of claim 17 wherein using a core balancing technique to assign the object, to a statistics job further comprises
representing each statistics job as a column comprising a plurality of cells, such that each cell represents at least one task related to an object;
assigning the object to a job according to at least one dimension so that the cumulative job size assigned to the statistics job is approximately equal to the cumulative job size assigned to each of the other statistics jobs in the schedule, so that each statistics job is assigned approximately the same amount of work.

20. The method of claim 17 wherein the reorganization task grid further comprises
a column for each job, such that the column comprises a plurality of cells, and such that each cell represents at least one reorganization task related to an object.

21. The method of claim 17 wherein using a core balancing technique to assign the object to a reorganization job further comprises
representing each reorganization job as a column comprising a plurality of cells, such that each cell represents at least one task related to an object;
assigning the object to a job according to at least one dimension so that the cumulative job size assigned to the reorganization job is approximately equal to the cumulative job size assigned to each of the other reorganization jobs in the schedule, so that each reorganization job is assigned approximately the same amount of work.

22. A method for balancing and scheduling database copy and balancing restore maintenance tasks for a database, the database comprising a plurality of database objects, the method comprising
defining characteristics for each of the plurality of database objects, the characteristics including an indicator of whether to force the object into a particular copy maintenance job;
scheduling copy tasks for the plurality of database objects by
establishing copy jobs and a copy task grid for a copy schedule, such that the task grid stores information about the objects that are assigned to copy jobs within the copy schedule,
assigning each database object of the plurality of database objects to a copy job by
forcing the object to a particular copy job, if the indicator designates a particular copy job,
using a core balancing technique to assign the object to a copy job, if the indicator does not designate a particular copy job, and
updating the copy job and task grid to reflect the assignment of the object to a copy job; and
executing the copy jobs.
generating restore tasks for the plurality of database objects from the copy task grid, by
establishing restore jobs for a restore schedule, such that the copy task grid stores information about the objects that are assigned to restore jobs within the restore schedule;
assigning each database object of the plurality of database objects to a restore job by
forcing the object to a particular restore job, if the indicator designates the particular restore job,
using a core balancing technique to assign the object to a restore job, if the indicator does not designate a particular restore job, and
updating the restore job and task grid to reflect the assignment of the object to a restore job.

23. The method of claim 22 wherein the copy task grid further comprises
a column for each job, such that the column comprises a plurality of cells, and such that each cell represents at least one maintenance task related to an object.

24. The method of claim 22 wherein using a core balancing technique to assign the object to a copy job further comprises
representing each copy job as a column comprising a plurality of cells, such that each cell represents at least one task related to an object;
assigning the object to a job according to at least one dimension so that the cumulative job size assigned to the copy job is approximately equal to the cumulative job size assigned to each of the other copy jobs in the schedule, so that each copy job is assigned approximately the same amount of work.

25. The method of claim 24 further comprising
assigning the object to a restore job according to at least one dimension so that the cumulative job size assigned to the restore job is approximately equal to the cumulative job size assigned to each of the other restore jobs in the schedule, so that each restore job is assigned approximately the same amount of work.
